(19) United States
(12) Patent Application Publication
(10) Pub. No.: US 2023/0154007 A1
(43) Pub. Date: May 18, 2023

(54) FEW-SHOT SEMANTIC IMAGE SEGMENTATION USING DYNAMIC CONVOLUTION

(71) Applicant: Elekta Limited, Crawley (GB)

(72) Inventors: Jie Liu, Amesterdam (NL); Jan-Jakob Sonke, Amsterdam (NL); Efstratios Gavves, Amsterdam (NL)

(21) Appl. No.: 18/055,674

(22) Filed: Nov. 15, 2022

Related U.S. Application Data
(60) Provisional application No. 63/264,068, filed on Nov. 15, 2021.

(51) Int. Cl. G06T 7/12; G06T 7/194; G06T 5/20; G06V 10/44; G06V 10/75

(52) U.S. Cl. CPC G06T 7/12; G06T 7/194; G06T 5/20; G06V 10/454; G06V 10/759; G06T 2207/20081; G06T 2207/20084

(57) ABSTRACT

A dynamic prototype convolution network (DPCN) can achieve sufficient information interaction between support features from a support image and query features from a query image for performing Few-shot semantic segmentation (FSS). A dynamic convolution module (DCM) can generate dynamic filters from a support foreground. Then, information interaction can be achieved by convolution operations over query features, such as by using these dynamic filters. A support activation module (SAM) and a feature filtering module (FFM) can be used to mine context information from a query feature. The SAM can learn to generate a pseudo mask for a query image. The FFM can refine the pseudo mask to filter background information from a query feature. Thus, information both from query and support can be used to achieve more accurate prediction. The DPCN can be used to perform k-shot segmentation.

### CLAIM OF PRIORITY

This patent application claims the benefit of priority of U.S. Provisional Patent Application Ser. No. 63/264,068, entitled “DYNAMIC PROTOTYPE CONVOLUTION NETWORK SUCH AS FOR FEW-SHOT SEMANTIC SEGMENTATION,” filed on Nov. 15, 2021 (Attorney Docket No. 4186.204PRV), which is hereby incorporated by reference herein in its entirety.

### TECHNICAL FIELD

This document pertains generally, but not by way of limitation, to image processing, and more particularly but not by way of limitation to image segmentation of medical or non-medical images using few-shot segmentation and dynamic convolution in parallel of multiple different kernels to generate one or more query features for performing the segmentation.

### BACKGROUND

Image segmentation refers to the computer-implemented task of clustering parts of an image together which belong to the same object class. Image segmentation can involve distinguishing between different types of imaged objects using imaging information that is obtained during imaging of the target object (e.g., from magnetic resonance, computed tomography, ultrasound, or other imaging modality). In a medical imaging illustrative example, image segmentation can involve determining which pixels or voxels are associated with a particular organ of interest within a patient, as differentiated from pixels and voxels that are associated with other structures within the patient, where such image segmentation can be performed using corresponding pixel or voxel intensity information.

Semantic image segmentation can further involve computer-implemented identifying or labeling or otherwise assigning meaning to a segmented object in an image dataset. Semantic information can include information about an object or feature. Semantic image segmentation can be performed using a computer, such as which can implement a deep convolutional neural network. Most approaches to semantic image segmentation involve using many training images with pixel-wise annotation, which can be used to train a learning model that, when trained, can be used to perform image segmentation. Generating the annotated training images can require huge human effort. Some semi-supervised or weakly-supervised learning approaches can help alleviate the expensive annotation cost to some extent. However, given only a few annotated samples of a novel object, both semi-supervised and weakly-supervised methods can face a significant performance drop, such as can be due to the poor generalization ability of the deep convolutional neural network.

### SUMMARY/OVERVIEW

Few-shot semantic image segmentation (FSS) can aim to train an image segmentation model that can fast adapt to novel classes of target objects in query images with only few exemplars from training support images. FSS can be used to help achieve dense prediction on novel objects given only a few annotated training support image samples. For example, FSS can be used to predict a binary mask of an unseen class of target objects given a few pairs of support images and given query images containing the same unseen class of target object and the binary ground truth masks for the support images.

FSS can be challenging because the novel classes of query images from a test set can be disjoint with the base classes of support images from a training set. With a view toward few-shot learning and meta-learning, certain FSS approaches can adopt an episode-based meta-learning strategy. Each episode can include the support set of support images and the query set of query images. The support set can include a few support images with pixel-wise annotation. A FSS learning model may be expected to learn to predict the image segmentation mask for query images in the query set, conditioned on support images in the support set. Learning can be based on episodes available with annotations during training of the learning model. At test time or run time, the trained image segmentation learning model can again be provided with episodes comprising a query set of query images and a support set of support images—but without requiring the annotations that were used during the training of the image segmentation learning model.

FSS can adopt a prototype learning paradigm. For example, prototype learning techniques can use mask average pooling, or they can cluster over support features, such as to generate few foreground or background prototypes. Such a prototype can include one or more representative vectors that can include representative information about a particular target object in one or more support images. Such prototypes generated from the one or more support images can then be used as prototype kernels that can be applied so as to interact with a query feature. Such support-query interactions can use one or more techniques to bring information about same-class or similar-class objects from the support image side over to the query side for helping segment the query image. For example, such support-query interactions can include using a cosine similarity measurement, an element-wise addition operation, or channel-wise concatenation, or other support-query interaction technique for bringing information from the support side over to the query side. An advantage of a prototype-based technique is that the prototypes can be more robust to noise interference than pixel features. However, in the context of FSS, there may only be a few support image sample prototypes available. It can be difficult for such limited prototypes to cover intrinsic and comprehensive information of a target object in the support image. This can be especially true when there is a large variation (e.g., appearance, scale, and shape) of the same-class of object present in the support image.

In addition, in certain approaches to FSS, information from both support features and query features may not be fully exploited. For support features, each prototype extracted from the support features may be isolated, for example, such that there is no intersection or overlap between the different prototypes. When the interaction between a support prototype and a query feature is insufficient, it may be difficult to mine detailed target object information from the query image. For instance, such as shown and described herein with respect to FIG. 1A, certain regions (e.g., the plant regions) can be over-segmented. If over-segmentation occurs, the predicted object in the query image may be larger than the original one because the predicted object may include background information that it should not include but that it does include due to the over-segmenting. Query features contain rich object-related context information that is complementary to that from a support feature to some extent, but this information is generally neglected in certain approaches.

To address the above issues, among other things, this document describes a dynamic prototype convolution network (DPCN). The DPCN can comprehensively mine information from both support and query features, which can then be used for FSS or other image segmentation, such as in training a learning model for use in generating a mask to perform image segmentation on query images. For the support branch, a dynamic convolution module (DCM) can be included, such as to help achieve more sufficient interaction between support features in support images and query features in query images, thus giving more powerful guidance to the segmentation of a query image. The DCM can include a group of multiple (e.g., three) dynamic kernels that can be generated from one or more support foreground features. The kernels can be considered dynamic, rather than static, in that the kernels are configured to be capable of changing based on a change in the input support images.

For instance, in an example that includes three different kernels, such individual kernels can respectively have different symmetry or asymmetry characteristics such as corresponding kernel dimensions d×1, d×d, and 1×d, respectively, such as shown and described herein with respect to FIG. 1B, wherein d can be an integer that represents a dimension of a vector or array of a particular individual kernel. Kernel generation is described in further detail with respect to FIG. 4. Then, three convolution operations can be concurrently carried out in parallel on a query feature with a corresponding dynamic kernel. This can help leverage information from interaction between support and query branches. This interaction strategy can help tackle large variations in target object scales and shapes across different images. For example, a square kernel (e.g., size d×d) can effectively capture main information of a target object, such as the main body of the plant in FIG. 1B. However, such a square kernel may exhibit poorer performance on tiny and slender parts like the leaves in FIG. 1B. On the contrary, an asymmetric kernel, such as a kernel with size d×1 or 1×d, can be much better at capturing tiny target object details. By combining different kernels, such as the different symmetry square kernel and asymmetric kernels, and using these different kernels for concurrently performing dynamic convolution on a query feature, better adaptability to the scale or shape variations in the target object can be obtained.

As there are usually large variations in one or more of appearance, scale, or shape, between target objects in support images and in query images, merely leveraging support information alone can make it difficult to precisely segment query images. Therefore, for the query branch, the present approach can include providing and using a support activation module (SAM) and a feature filtering module (FFM), such as to help mine as much object-related context information from a query image as possible. For example, “support activation” can involve using a support prototype to calculate a similarity with respect to various pixels in a query feature in a query image. Objects in the query feature that have a high similarity with the support feature will have a high similarity value.

The SAM can use support activation to help find an object in a query feature in a query image. For example, the SAM can be configured to use at least one relatively higher-level support and at least one relatively higher-level query feature to generate one or more support activation maps. A support activation map can provide a probabilistic representation of the object region in the query image. The support activation maps can include a colorized representation, such as with deeper colors representing those locations are more likely to include the object. These support activation maps can, in turn, be used to generate an initial query pseudo mask, such as can be from a determined pixel-wise mean or other central tendency taken over an internal dimension of a plurality (e.g., three) of the support activation maps. Then, the support prototypes and pseudo query foreground feature can be fused, such as to generate a refined pseudo mask for applying to a query image using the FFM. Such fusion can include combining the features to get a more informative feature map. Compared with the original pseudo query mask, the refined pseudo query mask will contain more target object foreground context, while filtering some noise information. Therefore, a query feature can obtain rich object-related context information, which can be beneficial to the final image segmentation.

To recap and provide an overview, the present techniques can include, among other things, as follows:
a dynamic prototype convolution network (DPCN) that can help implement sufficient interaction between one or more support kernels and one or more query features, such as can include using dynamic convolution in performing FSS;
a dynamic convolution module (DCM) that can help implement sufficient support-query interaction, such as with the DCM usable as a plug-and-play component that can also help improve other prototype learning approaches;
a support activation module (SAM) and feature filtering module (FFM) such as can help mine complementary information of target objects from a query image;
improved performance, including on certain benchmarks.

A numbered list of non-limiting examples or aspects is presented below as an overview.

Aspect 1 can optionally include a system, apparatus, device, computer-implemented method, computer-readable medium including instructions for being performed by a processor circuit for performing the method, among other things. Image segmentation can be performed on at least one query image. At least one query feature can be extracted from the query image, such as based on at least one support image, from which one or more support features are extracted. Different kernels can be generated from the one or more support features, such as can include using a computer-implemented kernel generator that can be included in or coupled to processor circuitry. The individual kernels can respectively have a different symmetry characteristic. This can help provide an appropriate support-query interaction, which can help provide improved segmentation, such as without over-segmentation or under-segmentation. Multiple concurrent convolutions can be performed over the query feature. This can include using the processor circuitry and the different kernels to propagate contextual information from at least one support feature to at least one query feature such as to produce one or more updated query features. The one or more updated query features can be used by the processor circuitry for segmenting the at least one query image to produce at least one predicted query mask.

Aspect 2 can optionally include the subject matter of Aspect 1, and can optionally further include performing support activation, such as can include using processor circuitry and a relatively higher level support feature and a relatively higher level query feature respectively associated with the at least one support image and the at least one query image. The support activation can be used to generate an initial pseudo-mask of a target object in the query image.

Aspect 3 can optionally include the subject matter of any of Aspects 1-2, and can optionally further include performing the support activation including by generating multiple activation maps, such as using the processor circuitry. The processor circuitry can also be used for performing region-to-region matching based on the higher level support feature, a corresponding binary support mask, and the higher level query feature.

Aspect 4 can optionally include the subject matter of any of Aspects 1-3, and can optionally further include the performing region-to-region matching including generating support regions and query regions using the processor circuitry and a fixed window respectively sliding on a corresponding support feature and a corresponding query feature.

Aspect 5 can optionally include the subject matter of any of Aspects 1-4, and can optionally further include generating multiple activation maps from which a mean can be determined to generate the initial pseudo-mask of the target object in the query image. The initial pseudo-mask can indicate a likelihood of the target object being found in one or more regions of the query image.

Aspect 6 can optionally include the subject matter of any of Aspects 1-5, and can optionally further include performing feature filtering. The feature filtering can include using the processor circuitry and the initial pseudo-mask and a relatively middle level support feature and a relatively middle level query feature, respectively associated with the at least one support image and the at least one query image, to generate a refined pseudo-mask, such as to help filter background information not associated with the higher level query feature.

Aspect 7 can optionally include the subject matter of any of Aspects 1-6, and can optionally further include the performing feature filtering including applying masked average pooling on support features to obtain a support prototype vector. The support prototype vector can be expanded, such as to match one or more dimensions of a feature map of the at least one query feature. This can include using target object information from both the at least one support feature and the at least one query feature. The pseudo-mask can be refined, such as can include using a two-dimensional (2D) convolutional layer followed by a sigmoid function. The middle level query feature can be combined with the refined pseudo-mask, such as to obtain a filtered query feature that filters background information not associated with the higher level query feature.

Aspect 8 can optionally include the subject matter of any of Aspects 1-7, and can optionally further include extracting the at least one query feature from at least one query image using a first convolutional neural network (CNN) included in or coupled to processor circuitry. One or more support features can be extracted from the at least one support image, such as can include using a computer-implemented second CNN included in or coupled to the processor circuitry.

Aspect 9 can optionally include the subject matter of any of Aspects 1-8, and can optionally further include segmenting the at least one query image using the processor circuitry and a pixel-wise annotated at least one support image.

Aspect 10 can optionally include the subject matter of any of Aspects 1-9, and can optionally further include performing multiple convolutions. The multiple convolutions can be performed concurrently. This can include, using the processing circuitry, inferring optimal kernel parameters for a subset of support features. This can be carried out without requiring semantic information about a query feature.

Aspect 11 can optionally include the subject matter of any of Aspects 1-10, and can optionally further include inferring optimal kernel parameters including by using at least one square kernel and at least two asymmetric kernels.

Aspect 12 can optionally include the subject matter of any of Aspects 1-11, and can optionally further include using the processor circuitry for performing K-shot segmentation using K support images and corresponding K masks, extracting foreground vectors together using K image-mask pairs.

Aspect 13 can optionally include the subject matter of any of Aspects 1-12, and can optionally further include training a convolutional neural network such as can include using binary cross-entropy loss (BCE) between a predicted mask and a ground truth mask.

Aspect 14 can optionally include the subject matter of any of Aspects 1-13, and can optionally further include a device-readable medium, including stored encoded instructions for configuring a processor for performing the method one or more of the numbered Aspects listed herein.

Aspect 15 can optionally include the subject matter of any of Aspects 1-14, and can optionally further include a system, device, method, computer-readable medium, or other aspect of semantic image segmentation of at least one query image associated with at least one query feature based on at least one support image associated with at least one support feature. This can include using at least one first support feature extracted from the at least one support image and at least one first query feature extracted from the at least one query image, generating an initial pseudo-mask of a target object in the query image. Using the initial pseudo-mask and at least one second support feature from the at least one support image and at least one second query feature from the at least one query image, a processor circuitry can be used for generating a refined pseudo-mask to filter background information not associated with the first query feature. The processor circuitry can further be used for performing multiple concurrent convolutions over the query feature using different kernels to propagate contextual information from at least one support feature to at least one query feature to produce one or more updated query features, wherein the different kernels are generated from the at least one first support feature and respectively have a different symmetry characteristic. The one or more updated query features can be used by the processor circuitry for segmenting the at least one query image to produce at least one predicted query mask.

Aspect 16 can optionally include the subject matter of any of Aspects 1-15, and can optionally further include performing support activation, using processor circuitry and a relatively higher level support feature and a relatively higher level query feature respectively associated with the at least one support image and the at least one query image, such as to generate an initial pseudo-mask of a target object in the query image.

Aspect 17 can optionally include the subject matter of any of Aspects 1-16, and can optionally further include performing the support activation including by generating multiple activation maps, using processor circuitry, by performing region-to-region matching based on the higher level support feature, a corresponding binary support mask, and the higher level query feature.

Aspect 18 can optionally include the subject matter of any of Aspects 1-17, and can optionally further include the performing region-to-region matching including generating support regions and query regions using the processor circuitry and a fixed window respectively sliding on a corresponding support feature and a corresponding query feature.

Aspect 19 can optionally include the subject matter of any of Aspects 1-18, and can optionally further include performing feature filtering, using the processor circuitry and the initial pseudo-mask and a relatively middle level support feature and a relatively middle level query feature, respectively associated with the at least one support image and the at least one query image, to generate a refined pseudo-mask to filter background information not associated with a higher level query feature.

Aspect 20 can optionally include the subject matter of any of Aspects 1-19, and can optionally further include the performing feature filtering including, using the processor circuitry: applying masked average pooling on support features to obtain a support prototype vector; expanding the support prototype vector to match one or more dimensions of a feature map of the at least one query feature, using target object information from both the at least one support feature and the at least one query feature; refining the pseudo-mask using a 2D convolutional layer followed by a sigmoid function; and combining the middle level query feature with the refined pseudo-mask to obtain a filtered query feature that filters background information not associated with the higher level query feature.

Aspect 21 can optionally include the subject matter of any of Aspects 1-20, and can optionally further include a system, device, method, computer-readable medium, or other aspect that can include: performing support activation, using processor circuitry and a relatively higher level support feature and a relatively higher level query feature respectively associated with the at least one support image and the at least one query image, to generate multiple activation maps from which a mean is determined to generate an initial pseudo-mask of a target object in the query image; performing feature filtering, using the processor circuitry and the initial pseudo-mask and a relatively middle level support feature and a relatively middle level query feature, respectively associated with the at least one support image and the at least one query image, to generate a refined pseudo-mask to filter background information not associated with the higher level query feature; performing multiple concurrent dynamic convolutions over the higher level query feature using the processor circuitry and different corresponding prototype kernels, respectively having a different symmetry characteristic, the kernels dynamically generated from the higher level support feature to propagate contextual information from at least one support feature to at least one query feature to produce updated query features; and providing the updated query features to a decoder, included in or coupled to the processor circuitry, for segmenting the at least one query image to produce at least one predicted query mask.

Aspect 22 can optionally include the subject matter of any of Aspects 1-21, and can optionally further include the performing the support activation comprising: generating the multiple activation maps, using the processor circuitry, by performing region-to-region matching based on the higher level support feature, a corresponding binary support mask, and the higher level query feature.

Aspect 23 can optionally include the subject matter of any of Aspects 1-22, and can optionally further include performing region-to-region matching including generating support regions and query regions using the processor circuitry and a fixed window respectively sliding on a corresponding support feature and a corresponding query feature.

Aspect 24 can optionally include the subject matter of any of Aspects 1-23, and can optionally further include performing feature filtering. The feature filtering can include, using the processing circuitry: applying masked average pooling on support features to obtain a support prototype vector; expanding the support prototype vector to match one or more dimensions of a feature map of the at least one query feature, using target object information from both the at least one support feature and the at least one query feature; refining the pseudo-mask using a 2D convolutional layer followed by a sigmoid function; and combining the middle level query feature with the refined pseudo-mask to obtain a filtered query feature that filters background information not associated with the higher level query feature.

This Summary/Overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A is a block diagram, including representative image information, describing aspects of certain prototype-based approaches, such as for comparative purposes.

FIG. 1B is a block diagram, including representative image information, describing aspects of an approach that can include dynamic kernel generation and dynamic convolution.

FIG. 2 is a block diagram showing an illustrative example of an architecture of portions of a computer-implemented dynamic prototype convolution network (DPCN), such as mentioned above with respect to FIG. 1B.

FIG. 3 is a block diagram showing an illustrative example of an arrangement of portions of a Support Activation Module (SAM).

FIG. 4 is a block diagram showing an illustrative example of an arrangement of the kernel generator, such as can be used in the dynamic convolution module (DCM).

FIG. 5 is a block diagram showing an illustrative example of qualitative results of using the described DPCN and a corresponding baseline model on a PASCAL-5ⁱ benchmark.

FIG. 6 illustrates an examples of portions of a radiotherapy system adapted for including the DPCN described herein.

FIG. 7 illustrates an example of portions of an image-guided radiotherapy device.

FIG. 8 depicts an example of portions of a radiation therapy system (e.g., such as a MR-Linac).

### DETAILED DESCRIPTION

Semantic segmentation is a dense prediction task that aims to classify each pixel of an image into a specific object category. Various networks can build upon fully convolutional networks (FCNs) to help further improve semantic segmentation performance. Some possible approaches may try to enlarge the reception field (e.g., a kernel size used in convolution) to capture more contextual information. To this end, some strategies such as dilated convolution, pyramid pooling, and deformable convolution, can be used such as to help to enlarge the reception field and can achieve improvement. Meanwhile, long-range dependencies can play a role in semantic segmentation. Accordingly, some approaches can include models that can then leverage an attention mechanism (e.g., a non-local module and its variants) to capture long-distance dependencies with a goal of reaching new state-of-the-art performance. However, these fully-supervised semantic segmentation approaches still suffer from poor generalizability under insufficient training data.

Few-shot semantic segmentation (FSS) can learn to segment target objects in a query image given a few pixel-wise annotated support images. Certain possible FSS approaches may adopt a two-branch architecture, such as that can implement meta-training on the base classes and can then conduct meta-testing on the disjoint novel classes. Certain approaches can involve generating or rearranging representative prototypes using different strategies. Then, the interaction of prototypes with query feature can be formulated as a few-to-many matching problem. However, these prototype learning methods may cause information loss due to a limited number of available prototypes. Therefore, graph-based methods can be used. Such graph-based methods can try to preserve structural information with many-to-many matching mechanism. For instance, attentive graph reasoning can be applied to propagate label information from support data to query data. Graph nodes can be constructed using multi-scale features and can be used to perform k-step reasoning over nodes to capture cross-scale information. In another approach, the FSS task can be approached from the perspective of visual correspondence, such as to implement efficient four-dimensional (4D) convolutions over multi-level feature correlation. The present approach can try to perform sufficient interaction between support and query features using dynamic convolution, such as to help mine as much complementary target information from both support and query features.

Dynamic convolution (e.g., dynamic filters) can be used to generate diverse dynamic kernels that can be convolved over an input feature. A dynamic kernel can change in response to a change in one or more input support images. Thus, while non-dynamic convolution is generally deterministic and will not change when the input support changes, by contrast, dynamic convolution will change when a kernel being convolved changes in response to a change in one or more input support images. Certain approaches can explore the effectiveness of dynamic convolution in deep neural networks. Dynamic convolution can be introduced into a few-shot target object detection task in image processing. This can include generating various kernels from the object regions in support image and then implementing convolution over query feature using these kernels. Such an approach can help lead to a more representative query feature. The present document describes, among other things, generating dynamic kernels from a foreground support feature, such as to interact with query feature by convolution. Instead of only using square kennels, different and asymmetric kernels can be used such as to help capture tiny and slender details of objects.

The problem setting can be a few-shot semantic segmentation setting, e.g., following an episode-based meta-learning paradigm. Classes Cₜᵣ, and Cₜₛ can represent the training set Dₜᵣ, and the test set Dₜₛ, respectively. A difference between FSS and a more general semantic segmentation task is that Cₜᵣ and Cₜₛ in the FSS task are disjoint, Cₜᵣ∩cₜₛ=0. Both Dₜᵣ and Dₜₛ can include thousands of randomly sampled episodes. Each episode (S,Q) includes a support set S, and a query set Q for a specific class c. For the K-shot setting, the support set that contains K image-mask pairs can be formulated as S={(Iₛⁱ,Mₛⁱ)}ᵢ₌₁^{K}, where Iₛⁱ represents ith support image and Mₛⁱ indicates corresponding binary mask.

Similarly, the query set can be defined as Q={(I_{q},M_{q})}, where I_{q} is query image and its binary mask M_{q} is only available in the model training phase. In the meta-training stage, the FSS model takes input S and I_{q} from a specific class c and generates a predicted mask M_{q} for the query image. Then the model can be trained with the supervision of a binary cross-entropy loss between M_{q} and \hat{M}_{q}, i.e., [symbol] _{BCE}(M_{q},\hat{M}_{q}). Finally, multiple episodes (Sᵢ^{ts},Qᵢ^{ts})ᵢ₌₁^{N}^{ₜₛ} can be randomly sampled from Dₜₛ for evaluation in the meta-testing stage.

For brevity and clarity, this document focuses on a 1-way setting, e.g., there is only one object category (way) needing segmentation in each query image. However, the present model can be evaluated under both a 1-shot and a 5-shot setting. A 1-shot setting refers to having one support image with pixel-wise annotation. A 5-shot setting refers to having 5 support images with corresponding pixel-wise annotations. An K-shot setting refers to having K support images with corresponding pixel-wise annotations. The 1-shot setting is focused on in this section to for illustrative clarity.

Given the support image, Iₛ, and the query image, I_{q}, a common feature extraction backbone can include shared weights to extract features, xₛ^{h} and x_{q}^{h}. A support activation module (SAM) can be included, such as to generate an initial pseudo mask. To incorporate relevant contextual information, a dynamic convolution module (DCM) can be employed. The DCM can learn to generate custom kernels given the query and the support set. The resulting features computed by the dynamic convolutions can be fed into a decoder to predict the final segmentation mask \hat{M}_{q} for the query image 104.

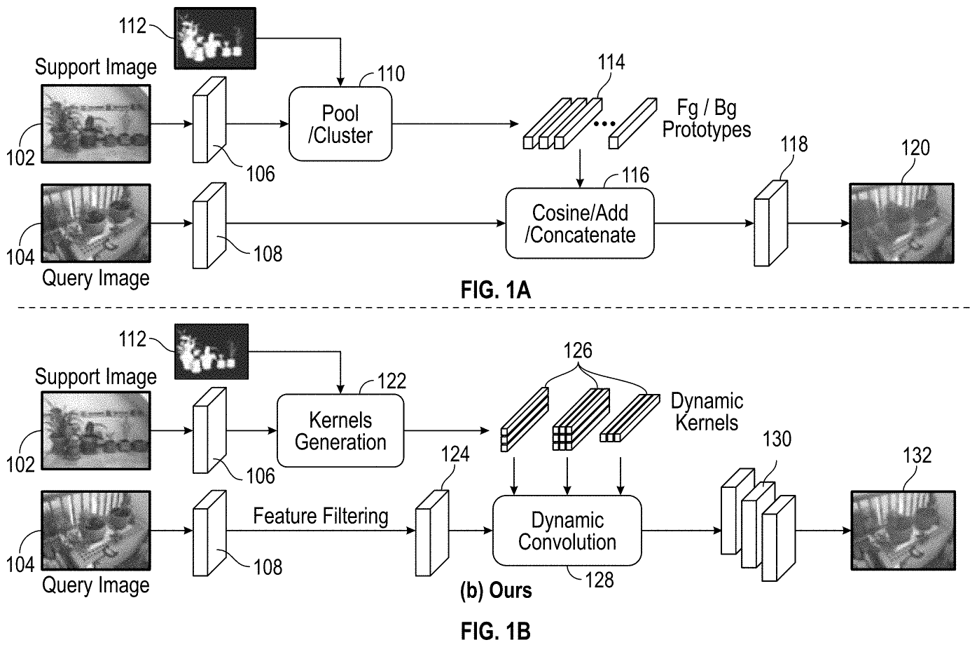

FIG. 1A is a block diagram, including representative image information, describing aspects of certain prototype-based approaches, such as for comparative purposes. FIG. 1A shows an example of a particular individual support image 102 and a particular individual query image 104. FIG. 1A also shows a support feature 106 that can be extracted from a support image 102 and a query feature 108 that can be extracted from a query foreground the query image 104. A computer-implemented pooling or clustering module 110 can be used to perform mask average pooling or clustering on one or more of the support features 106 from the support image 102. The pooling or clustering module 110 can receive a pixel-wise annotated support mask 112 and the support feature 106 from the support image 102 for performing its pooling or clustering, which yields one or more resulting prototypes 114. The prototypes 114 can include foreground prototypes, which can be associated with support features from the support foreground. The prototypes 114 can additionally or alternatively include background prototypes, which can be associated with support features from the support background.

A computer-implemented support-query interaction module 116 can be used to apply one or more of the prototypes 114 against one or more extracted query features 108. This can include using one or more of a cosine similarity measurement, element-wise add, or channel-wise concatenation operation to provide the support-query interaction. A resulting image segmentation mask 118 is generated, which, can then be used against the query image 104, such as for segmenting a target object in the query image 104, thereby yielding a resulting segmented image 120. As depicted in FIG. 1A, however, this approach can fail to segment the foliage or other details of the plants in the images shown. This may be due to insufficient support-query interaction, such that this approach cannot meet the appearance and shape variation.

FIG. 1B is a block diagram, including representative image information, describing aspects of dynamic prototype convolution network (DPCN) approach. FIG. 1B is similar to FIG. 1A in certain respects. In FIG. 1B, however, the query feature 108 can undergo computer-implemented feature filtering, such as described in further detail below, to yield a filtered query feature 124. A computer-implemented kernels generation module 122 can receive a pixel-wise annotated support mask 112 and the support feature 106 from the support image 102 for performing its kernels generation, which yields multiple differently dimensioned dynamic kernels 126. The illustrative example of FIG. 1B depicts three differently dimensioned dynamic kernels 126, such as can be generated from one or more support foreground features. These differently dimensioned dynamic kernels 126 can be used concurrently to perform dynamic convolution with the filtered query feature 124, such as using the computer-implemented dynamic convolution module 128, thereby generating corresponding image segmentation masks 130. These image segmentation masks 130 can then be used against the query image 104, such as for segmenting a target object in the query image 104, thereby yielding a resulting segmented image 132. The DPCN approach shown in FIG. 1B can well segment plants with complex shapes. The DPCN approach can benefit from dynamic convolution on a query feature 124 using the dynamic kernels 126 generated by the kernels generation module 122 using the foreground support feature 106.

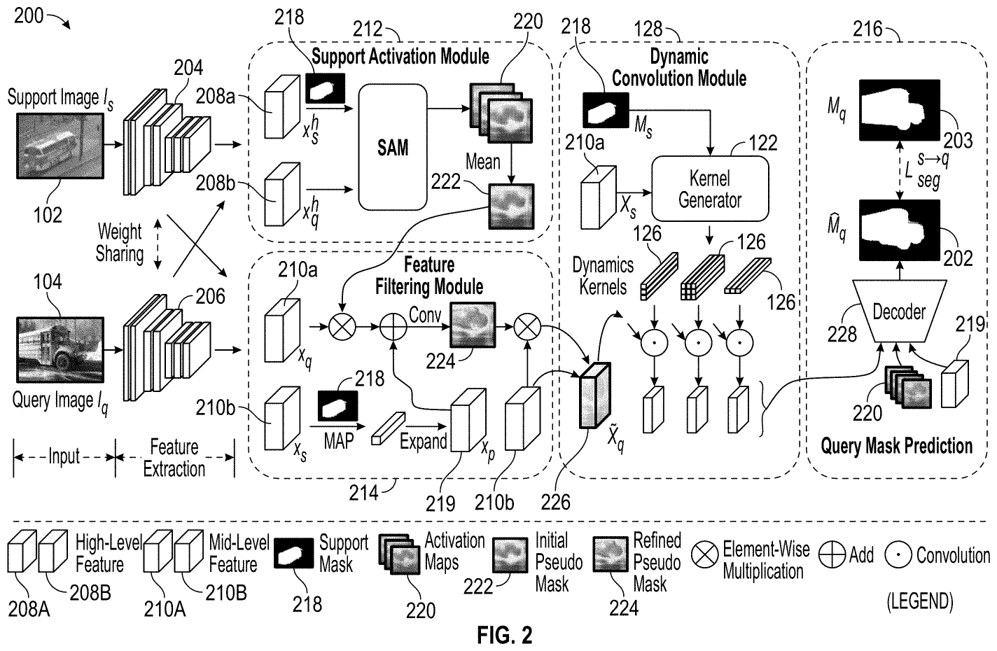

FIG. 2 is a block diagram showing an illustrative example of an architecture of portions of a computer-implemented dynamic prototype convolution network (DPCN) 200, such as mentioned above with respect to FIG. 1B. The DPCN 200 can use one or more support images 102 and one or more query images 104 to generate a segmentation mask 202 for segmenting a query feature from a query image 104. The DPCN 200 can include a support feature extractor 204 and a query feature extractor 206, each of which can include a corresponding convolutional neural network (CNN), which can be trained to perform the feature extraction, and the pair of which can share weights of individual or groups of nodes in the corresponding CNN. The CNNs employed can include a multi-layer CNN, such as shown by the series of layers depicted in FIG. 2. Relatively higher level features 208A-B can be extracted from layers in the CNN that are further in the series from the respective input images than other layers from which relatively lower or middle level features 210A-B can be extracted. The DPCN 200 can include a Support Activation Module (SAM) 212, a Feature Filtering Module (FFM) 214, a DCM 128, and a Segmentation Mask Generator (SMG) 216.

As shown by the crossed arrows in FIG. 2, either or both of the SAM 212 and the FFM 214 can use support-query interaction, such as explained herein. This can include, for example, support-query interaction using features from either or both of the support image 102 and the query image 104, sharing weights between neural network nodes of the CNNs of the respective feature extractors 204, 206, as well as the dynamic convolution described in further detail in this document.

The SAM 212 can use relatively high level support and query features 208A-B, with the support features annotated by a pixel-wise annotated or other support mask 218, to generate a plurality of support activation maps 220. These activation maps 220 can be averaged or otherwise combined to generate a resulting initial pseudo mask 222 of a target object in the query image 104, based on the high-level support and query features 208A-B.

The FFM 214 can receive as inputs mid-level support and query features 210A-B and the initial pseudo mask 222. The FFM 214 can use a middle level support feature 210 and its accompanying corresponding pixel-wise annotated or other support mask 218 to generate a prototype feature, which can be expanded into an expanded prototype feature 219 and added to the result of an element-wise multiplication of a mid-level query feature 210 with the initial pseudo mask 222 to produce a resulting refined pseudo mask 224. The refined pseudo mask 224 can be element-wise multiplied against the query feature 210 to filter most background information in the query feature 210, such as to produce a filtered query feature 226 that can be output from the FFM 214 to the DCM 128.

FFM 214 can be further explained as follows. Given the mid-level support feature 210, x_{S}ϵ [symbol] ^{C×H×W}, the mid-level query feature 210B x_{q}ϵ [symbol] ^{C×H×W}, as well as the initial pseudo mask 222, Mₚₛₑ⁰, the FFM 214 refines the initial pseudo mask 222, which can be used to filter out irrelevant background information in the query image 104. First, masked average pooling can be applied on the features from the support set to get

p=average(xₛ⊙ [symbol] (Mₛ)) (2)

where R reshapes the support mask 218 Mₛ to be the same shape as xₛ. Then, the support prototype vector p can be expanded to match the dimensions of the feature maps, xₚϵ [symbol] ^{C×H×W}, and to combine the target object information from both the support and query features. The initial pseudo mask 222 can be refined using a smaller network F, such as which can include a 2D convolution layer followed by a sigmoid function,

Mₚₛₑ^{r}= [symbol] ((x_{q}⊗Mₚₛₑ⁰)⊕xₚ)ϵ [symbol] ^{H×W} (3)

where ⊕ stands for the element-wise sum. Compared with Mₚₛₑ⁰, Mₚₛₑ^{r} gives a more accurate estimation of the target object location in the query image 104. Then, a final filtered query feature can be obtained, such as which discards irrelevant background by combining the feature x_{q} with the prior mask:

\tilde{x}_{q}=(x_{q}⊗Mₚₛₑ^{r})⊕x_{q}ϵ [symbol] ^{C×H×W} (4)

The DCM 128 can perform multiple concurrent convolutions of different prototype kernels 126, generated by a kernel generator 122 from a support foreground feature, against the filtered query feature 226 provided by the FFM 214. Doing this can help propagate rich context information from the support branch to the query feature. The different prototype kernels 126 can be generated by the kernel generator 122 using the middle level support feature 210 and its accompanying corresponding pixel-wise annotated or other support mask 218, such as explained with respect to FIG. 4. The resulting different kernels 126 can have different dimensions, which can include both symmetric and asymmetric dimensions. As explained herein, these different dimensions (e.g., d×1, d×d, and 1×d) of the kernels 126 can be helpful in applying against a variety of different types or different morphologies of features in the query image 104. The results of these concurrent convolutions are updated or enriched features that can be concatenated and then output by the DCM 128 to an input of a decoder 228 the SMG 216 for the final query segmentation mask prediction. The decoder 228 can include a convolutional neural network (CNN), such as which can have several convolutional layers, such as to make a mask prediction for the query image

The SMG 216 can include the decoder 228 having other inputs that can be configured to receive the activation maps 220 and the expanded query feature 219. The three inputs to the decoder 228 can be used by the decoder 228 to generate a query segmentation mask prediction 202, as explained in more detail herein. FIG. 2 also shows an example of a real (ground truth) mask 203 corresponding to the generated query segmentation mask prediction 202.

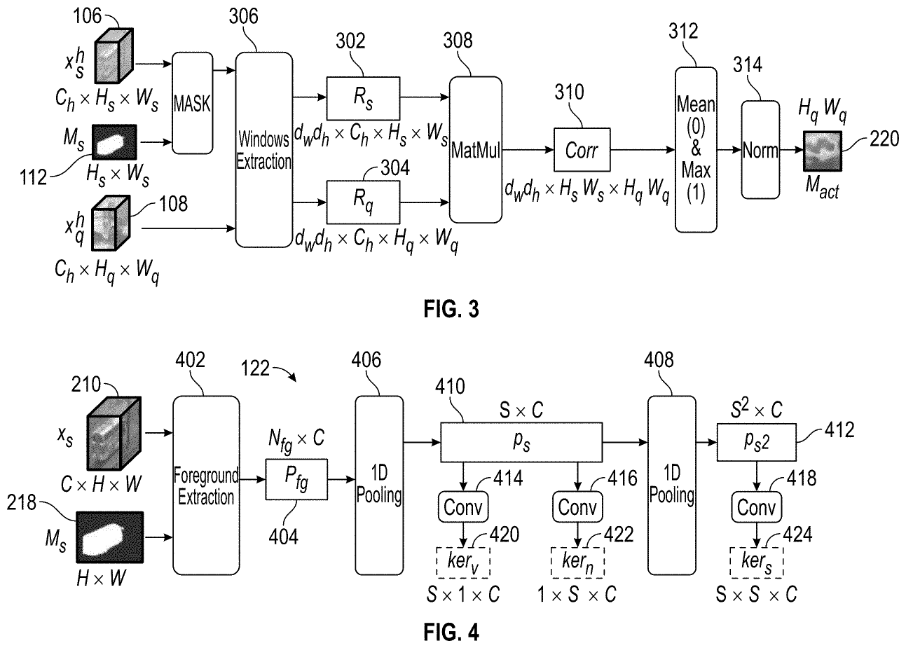

FIG. 3 is a block diagram showing an illustrative example of an arrangement of the Support Activation Module (SAM) 212. One possible approach to an FSS model would be to leverage high-level features from the support and query set to generate a prior mask indicating a rough location of the target object in the query image. If this prior mask is obtained by element-to-element matching between feature maps, context is not taken into account.

To counter this, the SAM 212 can generate multiple activation maps 220 of the target object in the query image 104, such as can include using region-to-region matching. For example, the SAM 212 can be configured to take as an input the high-level support feature 106, xₛ^{h}ϵ [symbol] ^{C}^{ₕ}^{×H}^{ₛ}^{×W}^{ₛ}, the corresponding binary mask 112, Mₛϵ [symbol] ^{H}^{ₛ}^{×W}^{ₛ}, as well as the high-level query feature 108, x_{q}^{h}ϵ [symbol] ^{C}^{ₕ}^{×H}^{_{q}}^{×W}^{_{q}}, where Cₕ is the channel dimension, Hₛ, Wₛ, H_{q}, W_{q} are the height and width of support feature 106 and query feature 108, respectively.

To perform region-to-region matching, support region features 302 Rₛ and query region features 304 R_{q} can be generated, such as using a fixed window 306 sliding on the support feature 106 and query feature 108, respectively, such as described in the below equation:

Rₛ=W(xₛ^{h}⊙Mₛ)ϵ [symbol] ^{d}^{ₕ}^{d}^{_{w}}^{×C}^{ₕ}^{×H}^{ₛ}^{W}^{ₛ}R_{q}=W(x_{q}^{h})ϵ [symbol] ^{d}^{ₕ}^{d}^{_{w}}^{×C}^{ₕ}^{×H}^{_{q}}^{W}^{_{q}} (10)

where ⊙ stands for the Hadamard product and dₕ, d_{w} are the window height and width. Performing region-to-region matching using a fixed window respectively sliding on a corresponding support feature and a corresponding query feature is a technique for computing a measure of similarity between different regions, somewhat like computing a cosine similarity or some other measure of similarity between the different regions. A region can be selected from the support feature and region can be selected from the query feature, and a similarity can be determined. For each query, there may be a lot of regions, such that determining a region-based similarity measure can be helpful. The fixed window can be fixed as the size of a particular region. In an example, both symmetrical and asymmetrical windows, (dₕ, d_{w})ϵ(5, 1), (3, 3), (1, 5), can be used, such as to help account for possible object geometries. Having the region features 302, 304, region-to-region matching 308 can be performed, such as by computing their cosine similarity, which generates the regional matching map 310, Corrϵ [symbol] ^{d}^{ₕ}^{d}^{_{w}}^{×H}^{ₛ}^{W}^{ₛ}^{×H}^{_{q}}^{W}^{_{q}}.

A final activation map 220, M_{act}ϵ [symbol] ^{H}^{_{q}}^{×W}^{_{q}}, can be generated at 312, such as by taking the mean value among all regions and the maximum value among all of the support features. For a case using three windows 306, three activation maps, {M_{act}ⁱ}ᵢ₌₁³, can be averaged or otherwise normalized at 314 to generate the initial pseudo-mask 222, Mₚₛₑ⁰ϵ [symbol] ^{H}^{_{q}}^{×W}^{_{q}}, which indicates the rough location of target objects in the query image 104.

FIG. 4 is a block diagram showing an illustrative example of an arrangement of the kernel generator 122, such as can be used in the DCM 128. As an initial matter, a foreground feature can be extracted from the query image 108. The extracted foreground feature can be minimally affected by irrelevant background. Still, the feature extraction and other initial operations may provide only a rough estimate of the location of the target object in the query image 108. For accurate image segmentation, however, much finer pixel-level predictions are desired. In the absence of significant data on which to train filters, dynamic convolutions can be performed, such as mentioned above.

Dynamic convolutions can employ meta-learning, such as to infer what are the optimal kernel parameters given a subset of features, agnostic to the unknown underlying class semantics. Specifically, a mid-level support feature 210, xₛ, and its corresponding binary support mask 218, Mₛ, can be input to the kernel generator 122, which generates different (e.g., differently dimensioned) dynamic kernels 126, e.g., one group that includes a square kernel and two groups that include asymmetrical kernels. Then, the DCM 128 can concurrently carry out three convolution operations over the filtered query feature 226, \tilde{x}_{q}, using the generated dynamic kernels 126. Firstly, a foreground vector extraction module 402 can be used to extract foreground vectors 404, P_{fg}, from the support feature 210, such as can be represented by:

P_{fg}= [symbol] ₑ(xₛ⊗Mₛ)ϵ [symbol] ^{N}^{_{fg}}^{×C} (5)

where Fₑ is the foreground extraction function without any learnable parameters, and where N_{fg} represents the number of foreground vectors. Next, two consecutive 1D pooling operations 406, 408 with corresponding respective kernel sizes S and S² can be leveraged to obtain two groups prototypes 410, 412 pₛϵ [symbol] ^{S×C} and pₛ_{²}ϵ [symbol] ^{s}^{²}^{×C}:

Pₛ=poolₛ(P_{fg}),pₛ_{²}=poolₛ_{²}(pₛ) (6)

As explained above, dynamic convolution can be achieved over a query feature, such as can include using a square kernel and two asymmetric kernels. In such an example, three parallel convolutional neural networks (CNNs) 414, 416, and 418 can be used, with respective outputs providing the corresponding generated kernel weights 420, 422, and 424:

kerᵥ= [symbol] _{conv1}(pₛ)ϵ [symbol] ^{S×1×C}kerₕ= [symbol] _{conv2}(pₛ)ϵ [symbol] ^{1×S×C}kerₛ= [symbol] _{conv3}(pₛ_{²})ϵ [symbol] ^{S×S×C} (7)

where kerᵥ; kerₕ; kerₛ are the vertical kernel weight 420, the horizontal kernel weight 422, and the square kernel weight 424, respectively. F_{conv1}, F_{conv2}, and F_{conv3} represent corresponding convolution sub-networks 414, 416, and 418, such as which can individually respectively include two consecutive one-dimensional (1D) convolution layers. The above parameter generating networks need not or do not share parameters. Given the vertical kernel 420 kerᵥ, the query feature \tilde{x}_{q}f can be enhanced as \tilde{x}_{q}^{v}ϵ [symbol] ^{C×H×W}:

\tilde{x}_{q}^{v}=\tilde{x}_{q}⊚kerᵥ (8)

where ⊚ denotes the dynamic convolution operation. Similarly, other enhanced query features \tilde{x}_{q}^{h}ϵ [symbol] ^{C×H×W} and \tilde{x}_{q}^{s}ϵ [symbol] ^{C×H×W} can be obtained, such as using the horizontal kernel 422 kerₕ and the square kernel 424 kerₛ, respectively. With the efficient interaction between the query feature and the dynamic support kernels 420, 422, and 424, the target object in the generated query feature can be enhanced and provided to the SMG 216.

The SMG 216 can concatenate the enhanced query feature \tilde{x}_{q}^{v}, \tilde{x}_{q}^{h}, \tilde{x}_{q}^{s}, support foreground feature xₚ, support activation maps {M_{act}ⁱ}ᵢ₌₁³ and refined pseudo mask Mₚₛₑ^{r} into a representative feature xₒᵤₜϵ [symbol] ^{(4C+4)×H×W}:

xₒᵤₜ= [symbol] _{cat}(\tilde{x}_{q}^{v},\tilde{x}_{q}^{h},\tilde{x}_{q}^{s},xₚ{M_{act}ⁱ}ᵢ₌₁³,Mₚₛₑ^{r}) (9)

where F_{cat} is the concatenation operation in channel dimension. Finally, xₒᵤₜ can be fed into a decoder 228 to generate a predicted segmentation mask 202, \hat{M}_{q}, for the query image 104, I_{q}:

\hat{M}_{q}= [symbol] _{cls}( [symbol] _{ASPP}( [symbol] _{conv}(xₒᵤₜ))) (10)

where F_{conv}, F_{ASPP}, and F_{cls}, are three consecutive modules that constitute the decoder 228.

### Extension to K-Shot Setting

So far, focus has been on the one-shot setting, such as illustrated in FIG. 2. For the K-shot setting, where more than one support images 102 are available, certain approaches can choose attention-based fusion or feature averaging. However, such a strategy may not make full use of the support information. By contrast, the dynamic convolutions can be extended to the K-shot setting, such as to help achieve substantial performance improvement. Specifically, given each support image-mask pair, foreground vectors can be extracted, such as explained above. By collecting all foreground vectors together, the overall support foreground vectors P_{fg} from K shots can be represented as:

P_{fg}=(P_{fg}¹,P_{fg}², . . . ,P_{fg}^{K})ϵ [symbol] ^{N}^{_{fg}}^{×C} (11)

where the number of foreground vectors is N_{fg}=Σᵢ₌₁^{K}N_{fg}ⁱ. By doing so, the kernel generator 122 in the DCM 128 can generate more robust dynamic kernels 126, thus leading to more efficient support-query interaction and more accurate query mask estimation.

### Training Loss

The present DPCN 200 can be trained in an end-to-end manner, such as using binary cross-entropy loss (BCE). Given a predicted mask \hat{M}_{q} and ground-truth mask M_{q} for a query image 104, I_{q}, the BCE loss between \hat{M}_{q} and M_{q} can be defined as the main loss:

$${ℒ}_{seg}^{s \to q} = \frac{1}{hw} {\sum }_{i = 1}^{h} {\sum }_{j = 1}^{w} BCE ( {\hat{M}}_{q} ( i , j ) , {M}_{q} ( i , j ) ) \qquad ( 12 )$$

Another branch can be implemented to estimate the support mask 218, such as can include using the query image 104, 4, and its corresponding predicted mask \hat{M}_{q}. Based on Eq. (10), the predicted support mask \hat{M}ₛ can be obtained. Then, another loss can be determined, such as by calculating the BCE loss between \hat{M}ₛ and Mₛ:

$${ℒ}_{seg}^{q \to s} = \frac{1}{{h}_{s} {w}_{s}} {\sum }_{i = 1}^{{h}_{s}} {\sum }_{j = 1}^{{w}_{s}} BCE ( {\hat{M}}_{s} ( i , j ) , {M}_{s} ( i , j ) ) \qquad ( 13 )$$

where hₛ and wₛ are the height and width of ground-truth mask Mₛ for the support image 102, Iₛ. Note that both query mask prediction and the support mask prediction process can share the same structure and parameters. The final loss can be represented as:

[symbol]

= [symbol] _{seg}^{s→q}+λ [symbol] _{seg}^{s→q} (14)

where λ is a weight to balance the contribution of each branch and was set to 1.0 in all experiments.

### Experiments

### Experimental Settings

Datasets. PASCAL-5ⁱ and COCO-20ⁱ were used as benchmarks for evaluation. PASCAL-5ⁱ comes from PASCAL VOC2012 and includes additional SBD annotations. It contains 20 object classes split into 4 folds, which can be used for 4-fold cross validation. For each fold, 5 classes can be used for testing and the remaining 15 classes can be used for training. COCO-20ⁱ is a more challenging benchmark, which is created from MSCOCO and contains 80 object classes. Similarly, the classes in COCO-20ⁱ can be split into 4 folds with 20 classes per fold. For each fold, 20 classes were used for testing and the remaining 60 classes were used for training.

Metrics and Evaluation. Mean intersection over union (mIoU) and foreground-background IoU (FB-IoU) can be adopted as metrics for evaluation. While FB-IoU neglects object classes and directly averages foreground and background IoU, mIoU averages IoU values of all classes in a fold. Therefore, mIoU can better reflect model segmentation performance. Thus, mIoU was the main focus of the experiments. During evaluation, 1,000 episodes (support-query pairs) from the test set were used for metrics calculation.

Implementation Details. ResNet-50 (VGG-16) pre-trained on ImageNet was used as a backbone network. The backbone weights are fixed except for layer4, which is useful to learn more robust activation maps. The model is trained with a SGD optimizer on PASCAL-5ⁱ for 200 epochs and COCO-20ⁱ for 50 epochs. The learning rate is initialized as 0.005 (0.0005 for layer4 of backbone) with batchsize 8 on both PASCAL-5ⁱ and COCO-20ⁱ. Data augmentation strategies are adopted in the training stage, and all images are cropped to 473×473 patches for the two benchmarks. In addition, the window sizes in the SAM 212 are set to {5×1; 3×3; 1×5}, and the kernel sizes of the kernels 126 in the DCM 128 are set as 5×1, 5×5, and 1×5, respectively. The model is implemented using PyTorch and all the experiments were conducted with Nvidia Tesla® V100 Graphics Processing Units (GPUs).

### Comparisons

PASCAL-5ⁱ Results. Table 1 shows data from computer-implemented experiments, including the mIoU and FBIoU under both 1-shot and 5-shot settings. From Table 1, it can be seen that the DPCN 200 can achieve new and improved state-of-the-art performance under both 1-shot and 5-shot settings. Especially for the 1-shot setting, performance of the DPCN 200 surpassed that of HSNet, by 2.0% and 2.7% with VGG16 and ResNet50 as backbone network, respectively. In addition, the DPCN 200 also presents comparable performance with HSNet under a 5-shot setting while using less midlevel features. Further, the DPCN 200 outperforms its baseline method by a large margin (e.g., mIoU 66.7% versus 61.4% with ResNet50 backbone for a 1-shot setting), which is implemented with same architecture except for the components of the DPCN 200 (e.g., such components can include the SAM 212, FFM 214, and DCM 128). This further demonstrates that the DPCN 200 can effectively mine complementary information from both support and query features such as to facilitate query image segmentation.

COCO-20ⁱ Results. COCO-20ⁱ is a more challenging benchmark that can contain multiple objects and can exhibit great variance. Table 2 presents a performance comparison of mIoU and FB-IoU on a COCO-20ⁱ dataset. As can be seen in Table 2, using VGG16 and ResNet50 as a backbone, the model DPCN 200 consistently outperforms other approaches in under both 1-shot and 5-shot settings. With ResNet50 backbone, DPCN achieves 3.8% mIoU improvement over HSNet under a 1-shot setting, and achieves comparable results for a 5-shot setting. In addition, the DPCN 200 demonstrates significant improvement over the baseline model. For example, the DPCN 200 using a VGG16 backbone achieves 5.6% and 3.9% mIoU improvement over the baseline model, which evidences the superiority of the present DPCN 200 approach in such challenging scenarios.

TABLE 1

| | | | | 1-shot | | | | 5-shot | | | | | |
|---|---|---|---|---|---|---|---|---|---|---|---|---|---|
| | | Fold- | Fold- | Fold- | Fold- | | FB- | | | Fold- | Fold- | | FB- |
| Methods | Backbone | 0 | 1 | 2 | 3 | Mean | IoU | Fold-0 | Fold-1 | 2 | 3 | Mean | IoU |
| OSLSM (BMCV′17) [18] | VGG16 | 33.6 | 55.3 | 40.9 | 33.5 | 40.8 | 61.3 | 35.9 | 58.1 | 42.7 | 39.1 | 43.9 | 61.5 |
| co-FCN (ICLRW′18) [17] | VGG16 | 36.7 | 50.6 | 44.9 | 32.4 | 41.1 | 60.1 | 37.5 | 50.0 | 44.1 | 33.9 | 41.4 | 60.2 |
| AMP-2(ICCV′19) [19] | VGG16 | 41.9 | 50.2 | 46.7 | 34.7 | 43.4 | 61.9 | 40.3 | 55.3 | 49.9 | 40.1 | 46.4 | 62.1 |
| PFENet (TPAMI′20 [22] | VGG16 | 56.9 | 68.2 | 54.4 | 52.4 | 58.0 | 72.0 | 59.0 | 69.1 | 54.8 | 52.9 | 59.0 | 72.3 |
| HSNet (ICCV′21)[15] | VGG16 | 59.6 | 65.7 | 59.6 | 54.0 | 59.7 | 73.4 | 64.9 | 69.0 | 64.1 | 58.6 | 64.1 | 76.6 |
| PFENet (TPAMI′20) [22] | ResNet50 | 61.7 | 69.5 | 55.4 | 56.3 | 60.8 | 73.3 | 63.1 | 70.7 | 55.8 | 57.9 | 61.9 | 73.9 |
| RePRI (CVPR′21) [ l ] | ResNet50 | 59.8 | 68.3 | 62.1 | 48.5 | 59.7 | — | 64.6 | 71.4 | 71.1 | 59.3 | 66.6 | — |
| SAGNN (CVPR′21) [26] | ResNet50 | 64.7 | 69.6 | 57.0 | 57.3 | 62.1 | 73.2 | 64.9 | 70.0 | 57.0 | 59.3 | 62.8 | 73.3 |
| SCL (CVPR′21) [31] | ResNet50 | 63.0 | 70.0 | 56.5 | 57.7 | 61.8 | 71.9 | 64.5 | 70.9 | 57.3 | 58.7 | 62.9 | 72.8 |
| MLC (ICCV′21) [28] | ResNet50 | 59.2 | 71.2 | 65.6 | 52.5 | 62.1 | — | 63.5 | 72.6 | 71.2 | 58.1 | 66.2 | — |
| MMNet (ICCV′21) [25] | ResNet50 | 62.7 | 70.2 | 57.3 | 57.0 | 61.8 | — | 62.2 | 71.5 | 57.5 | 62.4 | 63.4 | — |
| HSNet (ICCV′21) [15] | ResNet50 | 64.3 | 70.7 | 60.3 | 60.5 | 64.0 | 76.7 | 70.3 | 73.2 | 67.4 | 67.1 | 69.5 | 80.6 |
| Baseline | VGG16 | 58.4 | 68.0 | 58.0 | 50.9 | 58.8 | 71.2 | 60.7 | 68.8 | 60.2 | 52.2 | 60.4 | 74.3 |
| DPCN | VGG16 | 58.9 | 69.1 | 63.2 | 55.7 | 61.7 | 73.7 | 63.4 | 70.7 | 68.1 | 59.0 | 65.3 | 77.2 |
| Baseline | ResNet50 | 61.0 | 69.8 | 58.4 | 56.3 | 61.4 | 71.5 | 64.2 | 71.5 | 60.4 | 58.0 | 63.5 | 73.9 |
| DPCN | ResNet50 | 65.7 | 71.6 | 69.1 | 60.6 | 66.7 | 78.0 | 70.0 | 73.2 | 70.9 | 65.5 | 69.9 | 80.7 |

Comparison with state-of-the-arts on PASCAL-5' dataset under both 1-shot settings. mIoU of each fold, and averaged mIoU & FB-IoU of all folds are reported. Baseline results are achieved by removing three modules (i.e., SAM, FFM, and DCM) in DPCN. Best results are marked in bold.

| | | 1-shot | | | | | | 5-shot | | | | | |
|---|---|---|---|---|---|---|---|---|---|---|---|---|---|
| | | | Fold- | Fold- | Fold- | | FB- | | | Fold- | Fold- | | FB- |
| Methods | Backbone | Fold-0 | 1 | 2 | 3 | Mean | IoU | Fold-0 | Fold-1 | 2 | 3 | Mean | IoU |
| FWB(ICCV′19) [16] | VGG16 | 18.4 | 16.7 | 19.6 | 25.4 | 20.0 | — | 20.9 | 19.2 | 21.9 | 28.4 | 22.6 | — |
| PFENet(TPAMI′20) [22] | VGG16 | 33.4 | 36.0 | 34.1 | 32.8 | 34.1 | 60.0 | 35.9 | 40.7 | 38.1 | 36.1 | 37.7 | 61.6 |
| SAGNN(CVPR′21) [26] | VGG16 | 35.0 | 40.5 | 37.6 | 36.0 | 37.3 | 61.2 | 37.2 | 45.2 | 40.4 | 40.0 | 40.7 | 63.1 |
| RePRI(CVPR′21) [1] | ResNet50 | 31.2 | 38.1 | 33.3 | 33.0 | 34.0 | — | 38.5 | 46.2 | 40.0 | 43.6 | 42.1 | — |
| MLC(ICCV′21) [28] | ResNet50 | 46.8 | 35.3 | 26.2 | 27.1 | 33.9 | — | 54.1 | 41.2 | 34.1 | 33.1 | 40.6 | — |
| MMNet(ICCV′21) [25] | ResNet50 | 34.9 | 41.0 | 37.2 | 37.0 | 37.5 | — | 37.0 | 40.3 | 39.3 | 36.0 | 38.2 | — |
| HSNet(ICCV′21)[15] | ResNet50 | 36.3 | 43.1 | 38.7 | 38.7 | 39.2 | 68.2 | 43.3 | 51.3 | 48.2 | 45.0 | 46.9 | 70.7 |
| SAGNN(CVPR′21) [26] | ResNet50 | 36.1 | 41.0 | 38.2 | 33.5 | 37.2 | 60.9 | 40.9 | 48.3 | 42.6 | 38.9 | 42.7 | 63.4 |
| SCL(CVPR′21)[31] | ResNet50 | 36.4 | 38.6 | 37.5 | 35.4 | 37.0 | — | 38.9 | 40.5 | 41.5 | 38.7 | 39.9 | — |
| Baseline | VGG16 | 32.1 | 36.1 | 35.2 | 32.3 | 33.9 | 60.1 | 35.0 | 40.1 | 37.1 | 36.5 | 37.2 | 61.8 |
| DPCN | VGG16 | 38.5 | 43.7 | 38.2 | 37.7 | 39.5 | 62.5 | 39.2 | 45.4 | 40.3 | 39.5 | 41.1 | 63.1 |
| Baseline | ResNet50 | 31.5 | 37.8 | 33.6 | 31.8 | 33.7 | 57.4 | 34.5 | 40.9 | 36.8 | 34.6 | 36.7 | 59.1 |
| DPCN | ResNet50 | 42.0 | 47.0 | 43.2 | 39.7 | 43.0 | 63.2 | 45.0 | 50.6 | 46.8 | 44.0 | 46.6 | 64.1 |

Comparison with state-of-the-arts on COCO-20ⁱ dataset under both 1-shot settings. mIoU of each fold, and averaged mIoU & FB-IoU of all folds are reported. Baseline results are achieved by removing three modules (i.e., SAM, FFM, and DCM) in DPCN. Best results are marked in bold.

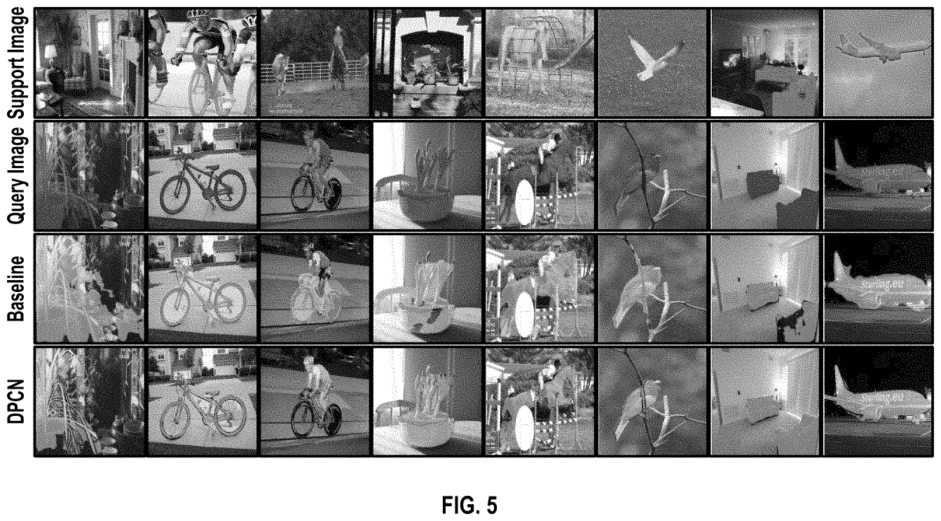

Qualitative Results. FIG. 5 is a collection of color images showing an illustrative example of qualitative image processing results of using the described DPCN 200 for performing image segmentation and using a corresponding baseline model on a PASCAL-5ⁱ benchmark dataset. Compared with the baseline, the DPCN 200 exhibits better performance in capturing object details. For instance, more tiny details are preserved in the image segmentation of the plant and bicycle target objects in the query images (e.g., such as shown in the first two columns in FIG. 5).

Ablation Study

To verify the effectiveness of the modules used in the DPCN 200, the following ablation studies were carried out with ResNet-50 under a 1-shot setting on the PASCAL-5ⁱ dataset.

Components Analysis. The DPCN 200 has been described as including various components. Such components can include the SAM 212, the FFM 214, and the DCM 128. Table 3 presents validation data demonstrating the effectiveness of each of these individual components. For example, using the DCM 128 in the DPCN 200 achieves 2.9% improvement in mIoU. The SAM 212 and FFM 214 are also helpful in providing performance improvement. By including all of these three modules in the DPCN 200, the DPCN 200 achieved new and improved state-of-the-art performance.

TABLE 3

| | | | 1-shot mIoU | | | | | |
|---|---|---|---|---|---|---|---|---|
| SAM | FFM | DCM | Fold-0 | Fold-1 | Fold-2 | Fold-3 | Mean | FB-IoU |
| ✓ | ✓ | | 63.6 | 69.7 | 65.0 | 59.6 | 64.5 | 75.2 |
| | ✓ | ✓ | 67.1 | 71.1 | 63.2 | 60.0 | 65.4 | 76.0 |
| ✓ | | ✓ | 63.5 | 70.8 | 65.7 | 58.9 | 64.7 | 75.8 |
| ✓ | ✓ | ✓ | 65.7 | 71.6 | 69.1 | 60.6 | 66.7 | 78.0 |

Abalation studies of main model components.

TABLE 4

| | 1-shot mIoU | | | | | |
|---|---|---|---|---|---|---|
| Kernel variants | Fold-0 | Fold-1 | Fold-2 | Fold-3 | Mean | FB-lou |
| w/o DCM | 63.6 | 69.7 | 62.1 | 59.6 | 63.8 | 74.0 |
| 5 × 5 | 64.7 | 71.2 | 65.3 | 58.7 | 65.0 | 76.2 |
| 1 × 5 | 64.9 | 71.0 | 65.2 | 59.7 | 65.2 | 75.4 |
| 1 × 5.5 × 1 | 63.2 | 71.4 | 64.8 | 59.2 | 64.7 | 75.4 |
| 1 × 5.5 × 5.5 × 1 | 65.7 | 71.6 | 69.1 | 60.6 | 66.7 | 78.0 |

Ablation studies on different kernel variants of DCM.

TABLE 5

| | 1-shot mIoU | | | | | |
|---|---|---|---|---|---|---|
| Methods | Fold-0 | Fold-1 | Fold-2 | Fold-3 | Mean | FB-IoU |
| 3 | 65.2 | 70.4 | 68.5 | 59.4 | 65.9 | 77.5 |
| 5 | 65.7 | 71.6 | 69.1 | 60.6 | 66.7 | 78.0 |
| 7 | 65.5 | 70.7 | 69.35 | 9.0 | 66.1 | 77.5 |
| 9 | 65.9 | 70.8 | 68.8 | 59.7 | 66.3 | 77.7 |

Ablation studies on different kernel variants of DCM.

TABLE 6

| | 1-shot mIoU | | | | | |
|---|---|---|---|---|---|---|
| Methods | Fold-0 | Fold- | Fold-2 | Fold-3 | Mean | FB-IoU |
| CANet | 53.5 | 65.9 | 51.3 | 51.9 | 55.4 | 66.2 |
| CANet + DCM | 64.7 | 65.7 | 51.8 | 51.9 | 58.5 | — |
| PFENe | 61.7 | 69.5 | 55.4 | 56.3 | 60.8 | 73.3 |
| PFENet + DCM | 62.2 | 69.6 | 59.2 | 58.0 | 62.3 | 73.5 |

Generalization ability of proposed DCM.

Kernel Variants in DCM. Dynamic kernels 126 are useful components in the DCM 128, so the effectiveness of different variants of the kernels 126 was explored. As shown in Table 4, the square kernel and the asymmetric kernels achieve almost similar results. However, the DPCN 200 yields better performance when choosing both square kernel and asymmetric kernels for use as the dynamic kernels 126.

Kernel size in the DCM 128. The kernel size was taken from 3, 5, 7, 9 to investigate the performance of the DPCN 200. Table 5 provides data indicating that the DPCN 200 achieves the best and second best performance when the kernel sizes are 5 and 9. The performance drops slightly when the kernel size is 3 or 7. Therefore, the kernel size was set to 5 in various experiments.

Generalization of the DCM 128. The DCM 128 can be used as a plug-and-play module such as to help further improve other prototype-based approaches. To verify this, the DCM 128 was applied to CANet and PFENet. Table 6 provides data indicating that the DCM 128 brings 3.1% and 1.5% mIoU improvement on CANet and PFENet, respectively.

Conclusions From Experiments. In this document, a DPCN 200 including the SAM 212, the FFM 214, and the DCM 128 is described to address the challenging FFS task. To better mine information from a query image, the SAM 212 and the FFM 214 can be used to generate a pseudo query mask and to filter background information such as to generate a refined pseudo query mask. In addition, a plug-and-play module DCM 128 is described to implement sufficient interaction between support and query features. The experiments demonstrate that the DPCN 200 achieved new and improved state-of-the-art performance on both PASCAL-5ⁱ and COCO-20ⁱ benchmarks.

Radiotherapy and Treatment Planning Implementation and Adaptation

While the present techniques are useful for FSS in general image segmentation and image-processing, such techniques are also particularly useful for use in image segmentation and other image processing in the context of radiotherapy treatment planning and control. Therefore, it is useful to describe how the present DPCN 200 can be used in radiotherapy treatment planning and control, which can include use of imaging from one or more imaging modalities (e.g., magnetic resonance (MR), computed tomography (CT), cone-beam CT (CBCT), or the like. For example, MR imaging, CBCT imaging, or both can be integrated with the apparatus used to deliver radiation therapy (radiotherapy) to the patient, such as described further below. More accurate “diagnostic quality” CT scanning (relative to “daily” CBCT) may be difficult to integrate with the radiation therapy apparatus and, therefore, may be unavailable during a particular radiation therapy session.

The imaging data can be used to plan and control delivery of radiation therapy to a target organ of a patient while avoiding delivering the radiation to other nearby organs, which are sometimes referred to as organs at risk (OARs). In such an application, the support image 102 can include, for example, an MR, CT, or CBCT image (e.g., of the same patient) that has previously been contoured, such as by a physician or other user, to provide the corresponding binary mask data that can serve as “ground truth” training data for training the image segmentation learning model. In this context, the FSS image segmentation may be performed on a “daily” CBCT query image, such as can be obtained by a CBCT imaging device integrated with the radiotherapy device. The segmented daily CBCT query image can then be used in radiotherapy treatment planning, in radiotherapy treatment delivery control, or both. Some examples of applying the present DPCN 200 in the context of radiation therapy treatment planning or radiation therapy delivery control are highlighted in Table 3 below, giving examples of how different types of support images and query images can be used in such context.

For example, the treatment planning may use such segmented image information to plan an appropriate radiotherapy fractional dose to be delivered to a target location or region within the patient. The treatment delivery control may use such segmented image information to control (e.g., by advance setting before therapy delivery, or adaptive setting allowing adjustment during therapy delivery in real-time) a Multi-Leaf Collimator (MLC) or other instrumentation used to determine the radiation dose and its desired volumetric morphology upon delivery to the target location or region within the patient. Thus, some overview of the present techniques in the context of radiation treatment planning or control may be helpful.

In overview, image guided radiation therapy (IGRT) is a technique that can make use of imaging of a patient, in treatment position, before delivering radiation to a target location or region of the patient. This allows more accurate targeting of the target location or region of the anatomy, such as can include an organ, a tumor, or organs-at-risk. The patient may move during treatment, such as by breathing. Breathing can create a quasi-periodic motion of a lung tumor. Similarly, filling of the patient's bladder may cause a position of the prostate to drift. To accommodate expected patient motion, additional margins may be placed around the target location or region to encompass the expected patient motion. These larger margins, however, can come at the expense of delivering a radiation dose to surrounding normal tissue, which may lead to increased side-effects.

IGRT may use computed tomography (CT) imaging, cone beam CT (CBCT), magnetic resonance (MR) imaging, positron-emission tomography (PET) imaging, or the like. Such imaging can be useful such as to obtain a 3D or 4D (which includes 3D over time) image of a patient before delivering the radiation dose. For example, a CBCT-enabled linac (linear accelerator) may include a kV source/detector affixed to a gantry at a 90 degree angle to a radiation beam. Or, a MR-Linac device may include a linac integrated directly with an MR scanner.

Localizing motion during the actual irradiation treatment delivery (intrafraction motion) may allow reduction of additional treatment margins that would otherwise be used to encompass motion, thus either allowing higher doses to be delivered, reduction of side-effects, or both. Certain IGRT imaging technologies are generally not sufficiently fast for imaging intrafractional motion. For example, CBCT can involve multiple kV images from various angles, which, in turn, can be used to reconstruct a full 3D patient image. Similarly, 3D MR imaging can involve multiple 2D slices, or filling of the full 3D k-space. Each of these scenarios may involve minutes of image-processing to generate a full 3D image for display.

In some cases, the real-time or quasi-real-time data that may be completely acquired before generating a 3D IGRT image, can be used as it is being gathered, such as to estimate the instantaneous 3D image at a much faster refresh rate from the incomplete, yet fast, stream of incoming information. For example, 2D kV projections or 2D MR slices may be used to estimate a full 3D CBCT-like or 3D MR-like image that evolves with the actual patient motion occurring during a radiation treatment session. Although fast, on their own, these 2D images may provide only a particular perspective of the patient, not the full 3D picture.

A patient state generator may receive partial measurements (e.g., a 2D image) as an input and generate (e.g., estimate) a patient state (e.g., a 3D image) as an output. To generate a patient state, the generator may use a single current partial measurement, a future (predicted) or past partial measurement, or a number of partial measurements (e.g., the last 10 measurements). These partial measurements may be from a single modality, such as an x-ray projection or MRI slice, or from multiple modalities, such as positions of reflective surface markers on the patient's surface synchronized with x-ray projections. A patient state may be a 3D image, or of ‘multi-modality,’ for example the patient state may include two or more 3D images that offer different information on the patient state, such as a ‘MR-like’ for enhanced tissue contrast, a ‘CT-like’ for high geometric accuracy and voxels related to density that are useful for dose calculations, or a ‘functional MR-like’ to provide function information about the patient. Patient state may also include non-imaging information. A patient state include one or more points of interest (such as a target position), contours, surfaces, deformation vector fields, or any information that is relevant to optimizing patient treatments.

Partial measurements described above may be received in a real-time stream of images (e.g., 2D images) taken from a kV imager or a MR imager, for example. The kV imager may produce stereoscopic 2D images for the real-time stream (e.g., two x-ray images that are orthogonal and acquired substantially simultaneously). The kV imager may be fixed in a room or coupled to a treatment device (e.g., attached to a gantry). The MR imager may produce 2D MR slices, which may be orthogonal or parallel. A patient state may be generated from an image or pair of images received. For example, at any given moment in time, the patient state for the last received image from the real-time stream may be generated.

In an example, a patient model may be based on data currently collected in a given fraction, in a pre-treatment phase (after the patient is set up and before the beam is turned on), from another fraction or during simulation/planning, using other patients, using generalized patient anatomy, using mechanical models, or any other information that may assist in defining a patient state from partial measurements. In an example, the patient model can include a 4D dataset, acquired pre-treatment, which models changes in patient state over a limited period of time (e.g., over a representative respiratory cycle). The patient model may be trained, (e.g., using a machine learning technique), to relate an input patient measurement (e.g., an image or pair of images from a real-time stream) to an output patient state, for example using a dictionary defining constructed patient measurements to corresponding patient states. The patient model may include a deformation vector field (DVF) as a function of one or more parameters.

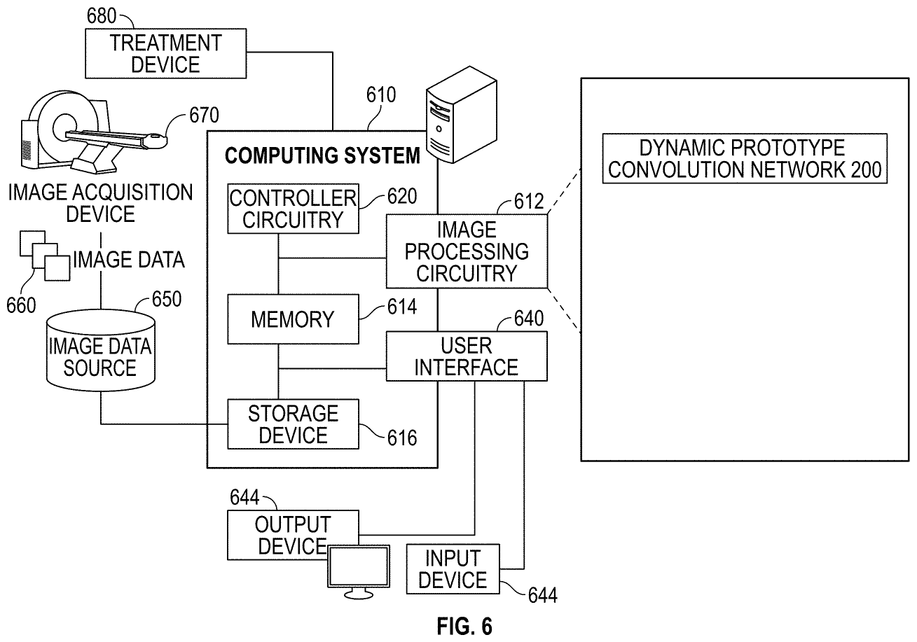

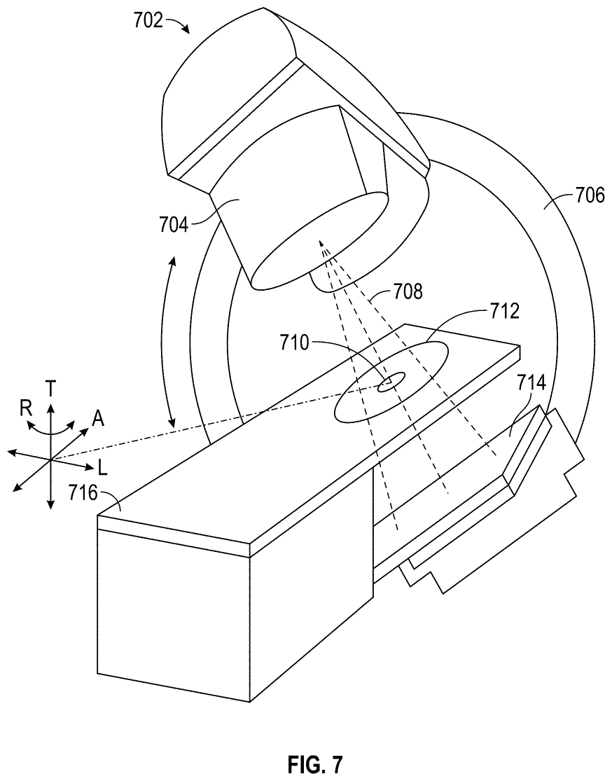

FIG. 6 illustrates an examples of portions of a radiotherapy system 600 adapted for including the DPCN 200 described herein. The DPCN 200 can be performed to perform image segmentation, information from which can be used to perform radiation treatment planning or to control operation of a radiation treatment device for providing radiation therapy to a patient based on specific aspects of captured medical imaging data.

The radiotherapy system 600 can include an image processing computing system 610, which can host the above-described DPCN 200, such as can be implemented by the image processing circuitry 612 executing or otherwise performing programming instructions, such as which can be stored in memory 614 circuitry. The FSS and other image segmentation techniques using the DPCN 200 as described herein can be implemented and performed by the processing circuitry 612, and the resulting image segmentation information can be used by controller circuitry 620, such as for use in generating a radiation therapy treatment plan or for controlling operation of one or more components of a radiation treatment device 680.

The image processing computing system 610 may be connected to a network telecommunications, computer, or other network. Such network may include or be connected to the Internet. For instance, a network can connect the image processing computing system 610 with one or more medical information sources (e.g., a radiology information system (RIS), a medical record system (e.g., an electronic medical record (EMR)/electronic health record (EHR) system), an oncology information system (OIS)), one or more image data sources 650, an image acquisition device 670, and the treatment device 680 (e.g., a radiation therapy device). As an example, the image processing computing system 610 can be configured to perform FSS or other image segmentation operations by executing instructions or data using the processing circuitry 612, as part of operations to generate and customize radiation therapy treatment plans to be used by the treatment device 180.

The image processing computing system 610 may include image processing circuitry 612, a memory 614, a storage device 616, and other hardware or software-operable features, such as can include a user interface 640, communication interface, and the like. The storage device 616 may store computer-executable instructions, such as an operating system, radiation therapy treatment plans (e.g., original treatment plans, adapted treatment plans, or the like), software programs (e.g., radiotherapy treatment plan software, artificial intelligence implementations such as deep learning models, machine learning models, and neural networks, etc.), and any other computer-executable instructions to be executed by the processing circuitry 612.

For example, the processing circuitry 612 may include a processing device, such as one or more general-purpose processing devices such as a microprocessor, a central processing unit (CPU), a graphics processing unit (GPU), an accelerated processing unit (APU), or the like. More particularly, the processing circuitry 112 may include a complex instruction set computing (CISC) microprocessor, a reduced instruction set computing (RISC) microprocessor, a very long instruction Word (VLIW) microprocessor, a processor implementing other instruction sets, or processors implementing a combination of instruction sets. The processing circuitry 612 may also be implemented by one or more special-purpose processing devices such as an application specific integrated circuit (ASIC), a field programmable gate array (FPGA), a digital signal processor (DSP), a System on a Chip (SoC), or the like. The processing circuitry 612 may include or be a special-purpose processor, rather than a general-purpose processor. The processing circuitry 612 may include one or more processing devices, such as a microprocessor from the Pentium™, Core™, Xeon™, or Itanium® family manufactured by Intel™, the Turion™, Athlon™, Sempron™, Opteron™, FX™, Phenom™ family manufactured by AMD™, or any of various processors manufactured by Sun Microsystems. The processing circuitry 612 may also include graphical processing units such as a GPU from the GeForce®, Quadro®, Tesla® family manufactured by Nvidia™, GMA, Iris™ family manufactured by Intel™, or the Radeon™ family manufactured by AMD™. The processing circuitry 612 may also include one or more accelerated processing units such as the Xeon Phi™ family manufactured by Intel™. The disclosed embodiments are not limited to any type of processor(s) otherwise configured to meet the computing demands of identifying, analyzing, maintaining, generating, and/or providing large amounts of data or manipulating such data to perform the methods disclosed herein. In addition, the term “processor” may include more than one processor, for example, a multi-core design or a plurality of processors each having a multi-core design. The processing circuitry 612 can execute sequences of computer program instructions, stored in memory 614, and accessed from the storage device 616, to perform various operations, processes, methods such as explained in greater detail elsewhere herein.

The memory 614 may comprise read-only memory (ROM), a phase-change random access memory (PRAM), a static random access memory (SRAM), a flash memory, a random access memory (RAM), a dynamic random access memory (DRAM) such as synchronous DRAM (SDRAM), an electrically erasable programmable read-only memory (EEPROM), a static memory (e.g., flash memory, flash disk, static random access memory) as well as other types of random access memories, a cache, a register, a compact disc read-only memory (CD-ROM), a digital versatile disc (DVD) or other optical storage, a cassette tape, other magnetic storage device, or any other non-transitory medium that may be used to store information including image, data, or computer executable instructions (e.g., stored in any format) capable of being accessed by the processing circuitry 612, or any other type of computer device. For instance, the computer program instructions can be accessed by the processing circuitry 612, read from the ROM, or any other suitable memory location, and loaded into the RAM for execution by the processing circuitry 612.

The storage device 616 may include a drive unit that can include a machine-readable medium on which is stored one or more sets of instructions and data structures (e.g., software) embodying or utilized by any one or more of the methodologies or functions described herein. The instructions may also reside, completely or at least partially, within the memory 614 and/or within the processing circuitry 612 during execution thereof by the image processing computing system 610, with the memory 614 and the processing circuitry 612 also constituting machine-readable media.

The memory device 614 or the storage device 616 may constitute a non-transitory computer-readable medium. For example, the memory device 614 or the storage device 116 may store or load instructions for one or more software applications on the computer-readable medium. Software applications stored or loaded with the memory device 614 or the storage device 616 may include, for example, an operating system for the computer system as well as for one or more software-controlled devices. The image processing computing system 610 may also operate a variety of software programs comprising software code for implementing the DPCN 200 and the user interface 640. Further, the memory device 614 and the storage device 616 may store or load an entire software application, part of a software application, or code or data that is associated with a software application, which is executable by the processing circuitry 612. The memory device 614 or the storage device 616 may store, load, or manipulate one or more radiation therapy treatment plans, imaging data, patient state data, dictionary entries, artificial intelligence model data, labels and mapping data, etc. Software programs may be stored not only on the storage device 616 and the memory 614 but also on a removable computer medium, such as a hard drive, a computer disk, a CD-ROM, a DVD, a HD, a Blu-Ray DVD, USB flash drive, a SD card, a memory stick, or any other suitable medium; such software programs may also be communicated or received over a network.

The image processing computing system 610 may include a communication interface, network interface card, and communications circuitry. An example of a communication interface may include, for example, a network adaptor, a cable connector, a serial connector, a USB connector, a parallel connector, a high-speed data transmission adaptor (e.g., such as fiber, USB 3.0, thunderbolt, and the like), a wireless network adaptor (e.g., such as a IEEE 802.11/Wi-Fi adapter), a telecommunication adapter (e.g., to communicate with 3G, 4G/LTE, and 5G, networks and the like), and the like. Such a communication interface may include one or more digital and/or analog communication devices that permit a machine to communicate with other machines and devices, such as with other remotely located components, such as via a network. The network may provide the functionality of a local area network (LAN), a wireless network, a cloud computing environment (e.g., software as a service, platform as a service, infrastructure as a service, etc.), a client-server, a wide area network (WAN), or the like. For example, the network may include a LAN or a WAN that may include other systems (e.g., including additional image processing computing systems or image-based components associated with medical imaging or radiotherapy operations).

The image processing computing system 610 may obtain image data 660 from the image data source 650, for hosting on the storage device 616 and/or the memory 614. The software programs operating on the image processing computing system 610 may convert medical images of one format (e.g., MRI) to another format (e.g., CT), such as by producing synthetic images, such as a pseudo-CT image. Also, the software programs may register or associate a patient medical image (e.g., a CT image or an MR image) with that patient's dose distribution of radiotherapy treatment (e.g., also represented as an image) so that corresponding image voxels and dose voxels are appropriately associated. Further, the software programs may substitute one or more functions of the patient images such as signed distance functions or processed versions of the images that emphasize some aspect of the image information. Such functions might emphasize edges or differences in voxel textures, or other structural aspects. The software programs may provide capability to visualize, hide, emphasize, or de-emphasize some aspect of anatomical features, patient measurements, patient state information, or dose or treatment information, within medical images. The storage device 616 and memory 614 may store and host data to perform these purposes, including the image data 660, patient data, and other data required to create and implement a radiation therapy treatment plan and associated patient state estimation operations.

The processing circuitry 612 may be communicatively coupled to the memory 614 and the storage device 616. The processing circuitry 612 may be configured to execute computer executable instructions stored thereon from either the memory 614 or the storage device 616. The processing circuitry 612 may execute instructions to cause medical images from the image data 660 to be received or obtained in memory 614, and processed using the patient state processing logic 620. For example, the image processing computing system 610 may receive image data 660 from the image acquisition device 670 or image data sources 650, such as via a communication interface and network, to be stored or cached in the storage device 616. The processing circuitry 612 may also send or update medical images stored in memory 614 or the storage device 616 via a communication interface to another database or data store (e.g., a medical facility database). One or more of the systems may form a distributed computing/simulation environment that can use a network to collaboratively perform the techniques described herein. In addition, such network may be connected to internet to communicate with servers and clients that reside remotely on the internet.

The processing circuitry 612 may utilize software programs (e.g., a treatment planning software) along with the image data 660 and other patient data to create a radiation therapy treatment plan. The image data 660 may include 2D or 3D images, such as from a CT or MR. The processing circuitry 612 may use one or more software programs to implement and perform the DPCN 200, such as can include using a machine learning algorithm (e.g., a regression algorithm).

Further, such software programs may use the DPCN 200 to implement a FSS or other image segmentation, such as using the techniques described herein. Based on such segmented image information, the processing circuitry 612 may then transmit an executable radiation therapy treatment plan via a communication interface and the network to the treatment device 680. The radiation therapy plan can be used by the treatment device 680 to treat a patient with radiation via the treatment device 680, consistent with treatment plan provided in view of the segmented image information. Other outputs and uses of the software programs and the patient state estimation workflow 630 may occur with use of the image processing computing system 610.

The processing circuitry 612 may execute one or more software programs that invoke the DPCN 200 to implement a treatment plan or one or more other functions including FSS or other image segmentation. The treatment plan may also be based on one or more other factors, such as a preliminary motion model, creation of a dictionary or other semantic information, a patient state, or the like. This can include using machine learning, patient state estimation, or one or more other aspects of automatic processing and/or artificial intelligence. For instance, the processing circuitry 612 may execute software programs that estimate a patient state using a machine learning trained system.

The image data 660 may include one or more MRI image (e.g., 2D MRI, 3D MRI, 2D streaming MRI, 4D MRI, 4D volumetric MRI, 4D cine MRI, etc.), functional MRI images (e.g., fMRI, DCE-MRI, diffusion MRI), Computed Tomography (CT) images (e.g., 2D CT, Cone beam CT, 3D CT, 4D CT), ultrasound images (e.g., 2D ultrasound, 3D ultrasound, 4D ultrasound), Positron Emission Tomography (PET) images, X-ray images, fluoroscopic images, radiotherapy portal images, Single-Photo Emission Computed Tomography (SPECT) images, computer generated synthetic images (e.g., pseudo-CT images), or the like. Further, the image data 660 may also include or be associated with medical image processing data, for instance, for one or more of training images, and ground truth images, contoured images, and dose images. The image data 660 may be received from the image acquisition device 670 and stored in one or more of the image data sources 650 (e.g., a Picture Archiving and Communication System (PACS), a Vendor Neutral Archive (VNA), a medical record or information system, a data warehouse, etc.). Accordingly, the image acquisition device 670 may comprise a MRI imaging device, a CT imaging device, a PET imaging device, an ultrasound imaging device, a fluoroscopic device, a SPECT imaging device, an integrated Linear Accelerator and MRI imaging device, or other medical imaging devices for obtaining the medical images of the patient. The image data 660 may be received and stored in any type of data or any type of format (e.g., in a Digital Imaging and Communications in Medicine (DICOM) format) that the image acquisition device 670 and the image processing computing system 610 may use to perform operations consistent with the techniques described herein.

The image acquisition device 670 may be integrated with the treatment device 680 as a single apparatus (e.g., a MRI device combined with a linear accelerator, also referred to as an “MR-linac”). Such an MR-linac can be used, for example, to determine a location of a target organ or a target tumor in the patient, so as to direct radiation therapy accurately according to the radiation therapy treatment plan to a predetermined target. For instance, a radiation therapy treatment plan may provide information about a particular radiation dose to be applied to each patient. The radiation therapy treatment plan may also include other radiotherapy information, such as beam angles, dose-histogram-volume information, the number of radiation beams to be used during therapy, the dose per beam, or the like.

The image processing computing system 610 may communicate with an external database, such as through a network to send and/or receive a plurality of various types of data related to image processing and radiotherapy operations. For example, an external database may include machine data that includes information associated with the treatment device 680, the image acquisition device 670, or one or more other machines relevant to radiotherapy or medical procedures. Machine data information may include radiation beam size, arc placement, beam “on” and “off” time duration, machine parameters, segments, multi-leaf collimator (MLC) configuration, gantry speed, MRI pulse sequence, or the like. The external database may include a storage device and may be equipped with appropriate database administration software programs. Further, such databases or data sources may include a plurality of devices or systems located either in a central or a distributed manner.

The image processing computing system 610 can collect and obtain data, and communicate with other systems, via a network using one or more communication interfaces, which can be communicatively coupled to the processing circuitry 612 and the memory 614. For instance, a communication interface may provide communication connections between the image processing computing system 610 and radiotherapy system components (e.g., permitting the exchange of data with external devices). The communication interface may include appropriate interfacing circuitry from an output device 642 or an input device 644 to connect to the user interface 640, which may include a hardware keyboard, a keypad, or a touch screen through which a user may input information into the radiotherapy system.

The output device 642 may include a display device that can output a displayed representation of the user interface 640 and one or more aspects, visualizations, or representations of the medical images. The output device 642 may include one or more display screens that display medical images, interface information, treatment planning parameters (e.g., contours, dosages, beam angles, labels, maps, etc.) treatment plans, a target, localizing a target or tracking a target, patient state estimations (e.g., a 3D image), or any related information to the user. The input device 644 connected to the user interface 640 may include a keyboard, a keypad, a touch screen, or any type of device that a user may input information to the radiotherapy system. Alternatively, the output device 642, the input device 644, and features of the user interface 640 may be integrated into a particular device such as a smartphone or tablet computer, e.g., Apple iPad®, Lenovo Thinkpad®, Samsung Galaxy®, etc.

Furthermore, some or all components of the radiotherapy system may be implemented as a virtual machine (e.g., via VMWare, Hyper-V, or like virtualization platforms). For instance, a virtual machine can be software that functions as hardware. Therefore, a virtual machine can include at least one or more virtual processors, one or more virtual memories, and one or more virtual communication interfaces that together function as hardware. For example, the image processing computing system 610, the image data sources 650, or like components, may be implemented as a virtual machine or within a cloud-based virtualization environment.

The patient state processing logic 620 or other software programs may cause the computing system to communicate with the image data sources 650 to read images into memory 614 and the storage device 616, or store images or associated data from the memory 614 or the storage device 616 to and from the image data sources 650. For example, the image data source 650 may be configured to store and provide a plurality of images (e.g., 3D MRI, 4D MRI, 2D MRI slice images, CT images, 2D Fluoroscopy images, X-ray images, raw data from MR scans or CT scans, Digital Imaging and Communications in Medicine (DICOM) metadata, etc.) that the image data source 650 hosts, from image sets in image data 660 obtained from one or more patients via the image acquisition device 670. The image data source 650 or other databases may also store data to be used by the DPCN 200 when executing a software program that performs image segmentation image-processing operations, or when creating a radiation therapy treatment plan. Further, various databases may store the data produced by the DPCN 200 or its machine learning models. This can include the network parameters constituting the model learned by the network and the resulting predicted data. The image processing computing system 610 thus may obtain and/or receive the image data 660 (e.g., 2D MRI slice images, CT images, 2D Fluoroscopy images, X-ray images, 3D MRI images, 4D MRI images, etc.) from the image data source 650, the image acquisition device 670, the treatment device 680 (e.g., a MRI-Linac), or other information systems, in connection with implementing, training, or performing the DPCN 200 such as part of treatment or diagnostic operations.

The image acquisition device 670 can be configured to acquire one or more images of the patient's anatomy for a region of interest (e.g., a target organ, a target tumor, or both). Each image, such as a 2D image or slice, can include one or more parameters (e.g., a 2D slice thickness, an orientation, and a location, etc.). The image acquisition device 670 can acquire a 2D slice in any orientation. For example, an orientation of the 2D slice can include a sagittal orientation, a coronal orientation, or an axial orientation. The processing circuitry 612 can adjust one or more parameters, such as the thickness and/or orientation of the 2D slice, to include the target organ and/or target tumor. In an example, 2D slices can be determined from information such as a 3D MRI volume. Such 2D slices can be acquired by the image acquisition device 670 in “near real-time” while a patient is undergoing radiation therapy treatment, for example, when using the treatment device 680 (with “near real-time” meaning acquiring the data in at least milliseconds or less).

The DPCN 200 can be used for image segmentation, such as for use in generating a radiation therapy treatment plan, such as within use of software programs such as treatment planning software, such as Monaco®, manufactured by Elekta AB of Stockholm, Sweden. In generating the radiation therapy treatment plans, the image processing computing system 610 may communicate with the image acquisition device 670 (e.g., a CT device, a MRI device, a PET device, an X-ray device, an ultrasound device, etc.) such as to capture and access images of the patient and to delineate a target, such as a tumor. Delineation of one or more organs at risk (OARS), such as healthy tissue surrounding the tumor or in close proximity to the tumor, may additionally or alternatively be performed.

In delineating a target organ or a target tumor from the OAR, medical images, such as MRI images, CT images, PET images, fMRI images, X-ray images, ultrasound images, radiotherapy portal images, SPECT images or the like, of the patient undergoing radiotherapy may be obtained non-invasively by the image acquisition device 670 to reveal the internal structure of a body part. Based on the information from the medical images, a 3D structure of the relevant anatomical portion may be obtained. In addition, during a treatment planning process, many parameters may be taken into consideration, such as to help achieve a balance between efficient treatment of the target tumor (e.g., such that the target tumor receives enough radiation dose for an effective therapy) and low irradiation of the OAR(s) (e.g., the OAR(s) receives as low a radiation dose as possible). Efficient and accurate image segmentation by the DPCN 200 can be helpful to determine where OAR(s) may be at a given time, particularly when the patient is moving (e.g., breathing). Other parameters that may be considered include the location of the target organ and the target tumor, the location of the OAR, and the movement of the target in relation to the OAR. For example, the 3D structure may be obtained by contouring the target or contouring the OAR within each 2D layer or slice of an MRI or CT image and combining the contour of each 2D layer or slice. The contour may be generated manually (e.g., by a physician, dosimetrist, or health care worker using a program such as MONACO™ manufactured by Elekta AB of Stockholm, Sweden) or automatically (e.g., using image segmentation that can include using the DPCN 200 described herein).

After the target tumor and the OAR(s) have been located and delineated, a dosimetrist, physician or healthcare worker may determine a dose of radiation to be applied to the target tumor, as well as any maximum amounts of dose that may be received by the OAR proximate to the tumor (e.g., left and right parotid, optic nerves, eyes, lens, inner ears, spinal cord, brain stem, and the like). After the radiation dose is determined for a particular segmented or contoured anatomical structure (e.g., target tumor, OAR), a process known as inverse planning may be performed to determine one or more treatment plan parameters that would achieve the desired radiation dose distribution. Examples of treatment plan parameters can include volume delineation parameters (e.g., which define target volumes, contour sensitive structures, etc.), margins around the target tumor and OARs, beam angle selection, collimator settings, and beam-on times. During the inverse-planning process, the physician may define dose constraint parameters that set bounds on how much radiation an OAR may receive (e.g., defining full dose to the tumor target and zero dose to any OAR; defining 95% of dose to the target tumor; defining that the spinal cord, brain stem, and optic structures receive ≤45Gy, ≤55Gy and <54Gy, respectively). The result of inverse planning may constitute a radiation therapy treatment plan that may be stored. Some of these treatment parameters may be correlated. For example, tuning one parameter (e.g., weights for different objectives, such as increasing the dose to the target tumor) in an attempt to change the treatment plan may affect at least one other parameter, which, in turn, may result in the development of a different treatment plan. Thus, the image processing computing system 610 can generate a tailored radiation therapy treatment plan having these parameters in order for the treatment device 680 to provide suitable radiotherapy treatment to the patient.

FIG. 7 illustrates an example of portions of an image-guided radiotherapy device 702. The image-guided radiotherapy device can include a radiation source, such as an X-ray source or a linear accelerator, a couch 716, an imaging detector 714, and a radiation therapy output 704. The radiation therapy device 702 may be configured to emit a radiation beam 708 to provide therapy to a patient. The radiation therapy output 704 can include one or more attenuators or collimators, such as a multi-leaf collimator (MLC) that can be adjusted such as to tailor the beamshape of the radiation for a particular incident direction.

A patient can be positioned in a region 712, supported by the treatment couch 716 to receive a radiation therapy dose according to a radiation therapy treatment plan. The radiation therapy output 704 can be mounted or attached to a gantry 706 or other mechanical support. One or more chassis motors (not shown) may rotate the gantry 706 and the radiation therapy output 704 around the couch 716 when the couch 716 is inserted into the treatment area. The gantry 706 may be continuously rotatable around the couch 716 when the couch 716 is inserted into the treatment area. The gantry 706 may rotate to a predetermined position when the couch 716 is inserted into the treatment area. For example, the gantry 706 can be configured to rotate the therapy output 704 around an axis (“A”). Both the couch 716 and the radiation therapy output 704 can be independently moveable to other positions around the patient, such as moveable in transverse direction (“T”), moveable in a lateral direction (“L”), or as rotation about one or more other axes, such as rotation about a transverse axis (indicated as “R”). A controller communicatively connected to one or more actuators may control the couch 716 movements or rotations in order to properly position the patient in or out of the radiation beam 708 according to a radiation therapy treatment plan. The couch 716 and the gantry 706 are independently moveable from one another in multiple degrees of freedom. This allows the patient to be positioned such that the radiation beam 708 precisely can target the tumor.

The coordinate system (including axes A, T, and L) shown in FIG. 7 can have an origin located at an isocenter 710. The isocenter 710 can be defined as a location at which a central axis of the radiation therapy beam 708 intersects the origin of a coordinate axis, such as to deliver a prescribed radiation dose to a location on or within a patient. Alternatively, the isocenter 710 can be defined as a location where the central axis of the radiation therapy beam 708 intersects the patient for various rotational positions of the radiation therapy output 704 as positioned by the gantry 706 around the axis A.

The gantry 706 may also have an attached imaging detector 714. The imaging detector 714 can be located opposite to the radiation source (output 704), such as within a field of the therapy beam 708.

The imaging detector 714 can be mounted on the gantry 706 preferably opposite the radiation therapy output 704, such as to maintain alignment with the therapy beam 708. The imaging detector 714 can rotate about the rotational axis as the gantry 706 rotates. In an example, the imaging detector 714 can include a flat panel detector (e.g., a direct detector or a scintillator detector). The imaging detector 714 can be used to monitor the therapy beam 708 or the imaging detector 714 can be used for imaging the patient's anatomy, such as portal imaging. The control circuitry of radiation therapy device 702 may be integrated within the radiotherapy system or remote from it.

One or more of the couch 716, the therapy output 704, or the gantry 706 can be automatically positioned. The therapy output 704 can establish the therapy beam 708 according to a specified dose for a particular therapy delivery instance. A sequence of therapy deliveries can be specified according to a radiation therapy treatment plan, such as using one or more different orientations or locations of the gantry 706, the couch 716, or the therapy output 704. The therapy deliveries can occur sequentially, but can intersect in a desired therapy locus on or within the patient, such as at the isocenter 710. A prescribed cumulative dose of radiation therapy can thereby be delivered to the therapy locus while damage to tissue nearby the therapy locus can be reduced or avoided.

Thus, FIG. 7 specifically illustrates an example of a radiation therapy device 702 operable to provide radiotherapy treatment to a patient, with a configuration where a radiation therapy output can be rotated around a central axis (e.g., an axis “A”). Other radiation therapy output configurations can be used. For example, a radiation therapy output can be mounted to a robotic arm or manipulator having multiple degrees of freedom. Or, the therapy output can be fixed, such as located in a region laterally separated from the patient, and a platform supporting the patient can be used to align a radiation therapy isocenter with a specified target locus within the patient. The radiation therapy device can include a combination of a linear accelerator and an image acquisition device. The image acquisition device may include an MRI, an X-ray, a CT, a CBCT, a spiral CT, a PET, a SPECT, an optical tomography, a fluorescence imaging, ultrasound imaging, an MR-linac, or radiotherapy portal imaging device, or the like.

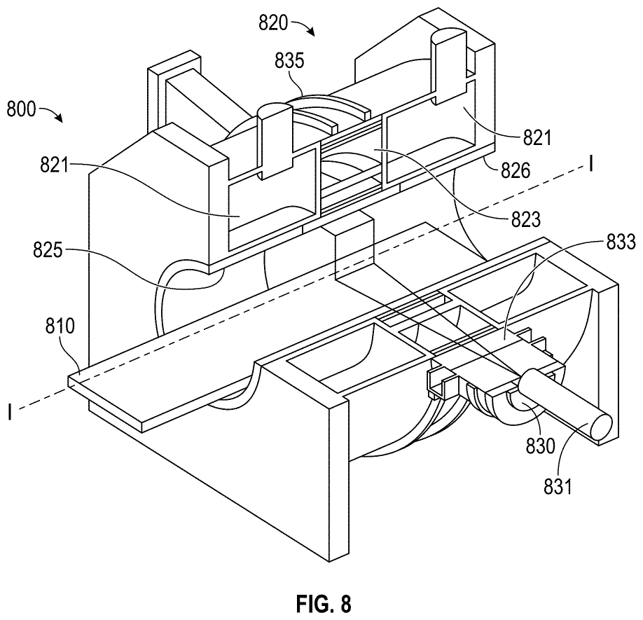

FIG. 8 depicts an example of portions of a radiation therapy system 800 (e.g., such as a MR-Linac). The radiation therapy system 800 can combine a radiation therapy device 702 and an imaging system, such as a nuclear magnetic resonance (MR) imaging system. As shown, the system 800 may include a couch 810, an image acquisition device 820, and a radiation delivery device 830. The system 800 can deliver radiation therapy to a patient in accordance with a radiotherapy treatment plan.

The couch 810 may support a patient during a treatment session. The couch 810 may move along a horizontal, translation axis (labelled “I”), such as to move the patient resting on the couch 810 into or out of system 800. The couch 810 may also rotate around a central vertical axis of rotation, transverse to the translation axis. To allow such movement or rotation, the couch 810 may include one or more motors enabling the couch 810 to move in various directions and to rotate along various axes. A controller circuit may control these movements or rotations such as to properly position the patient according to a treatment plan.

The image acquisition device 820 may include an MRI machine used to acquire 2D or 3D MRI images of the patient before, during, or after a treatment session. The image acquisition device 820 may include a magnet 821 for generating a primary magnetic field for magnetic resonance imaging. The magnetic field lines generated by operating the magnet 821 may run substantially parallel to the central translation axis I. The magnet 821 may include one or more coils with an axis that runs parallel to the translation axis I. The one or more coils in the magnet 821 may be spaced such that a central window 823 of magnet 821 is free of coils. The coils in the magnet 821 may be thin enough or of a reduced density such that they are substantially transparent to radiation of the wavelength generated by radiotherapy device 830. The image acquisition device 820 may also include one or more shielding coils, which may generate a magnetic field outside of the magnet 821 of approximately equal magnitude and opposite polarity such as to cancel or reduce any magnetic field outside of the magnet 821. As described below, the radiation source 831 of the radiotherapy device 830 may be positioned in the region where the magnetic field is cancelled, at least to a first order, or reduced.

The image acquisition device 820 may also include two gradient coils 825 and 826, which may generate a gradient magnetic field that is superposed on the primary magnetic field. The coils 825 and 826 may generate a gradient in the resultant magnetic field that allows spatial encoding of the radiation so that their position can be determined. The gradient coils 825 and 826 may be positioned around a common central axis with the magnet 821, and may be displaced along that central axis. The displacement may create a gap, or window, between the coils 825 and 826. The magnet 821 may include a central window 823 between coils, such that the two windows may be aligned with each other.

The radiotherapy device 830 may include the source of radiation 831, such as an X-ray source or a linear accelerator, and a multi-leaf collimator (MLC) 833. The radiotherapy device 830 may be mounted on a chassis 835. One or more chassis motors may rotate the chassis 835 around the couch 810 when the couch 810 is inserted into the treatment area. The chassis 835 may be continuously rotatable around the couch 810 when the couch 810 is inserted into the treatment area. The chassis 835 may also include an attached radiation detector, such as can be located opposite to the radiation source 831 and with the rotational axis of the chassis 835 positioned between the radiation source 831 and the detector. Further, the device 830 may include control circuitry such as can be used to control one or more of the couch 810, the image acquisition device 820, and the radiotherapy device 830. The control circuitry of the radiotherapy device 830 may be integrated within the system 800 or remote from it.

During a radiotherapy treatment session, a patient may be positioned on the couch 810. The system 800 may then move the couch 810 into the treatment area defined by the magnetic coils 821, 825, 826, and the chassis 835. The control circuitry may then control the radiation source 831, the MLC 833, and one or more chassis motors, such as to deliver radiation to the patient through the window between the coils 825 and 826 according to a radiotherapy treatment plan.

### Illustrative Radiation Treatment Planning or Delivery Control Examples

Table 3 provides some illustrative examples of applying the present DPCN 200 in the context of radiation therapy treatment planning or radiation therapy delivery control, illustrating how different types of support images and query images may be used in applying the DPCN in the context of radiotherapy.

TABLE 3
Support Image and Query Image Examples for Radiotherapy

| Support Image 102 | Query Image 104 |
|---|---|
| Anatomy (e.g., Target Organ or | Anatomy (e.g., Target Organ or |
| Organ At Risk (OAR) or other | Organ At Risk (OAR) or other |
| anatomic structure) contoured | anatomic structure), unannotated |
| by physician | |
| Diagnostic CT image, annotated | CBCT image, unannotated |
| CBCT image, previously contoured | CBCT image, unannotated |

While the present description focuses on using X-ray or CT-based imaging modalities for obtaining the support images, the query images, or both, other imaging modalities can also be used, such as magnetic resonance (MR), positron emission tomography (PET), ultrasound, or any other desired imaging modality.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A computer-implemented method of image segmentation of at least one query image, from which at least one query feature is extracted, based on at least one support image, from which one or more support features are extracted, the computer-implemented method comprising:
generating different kernels from the one or more support features, using a computer-implemented kernel generator included in or coupled to processor circuitry, the kernels respectively having a different symmetry characteristic;
performing multiple concurrent convolutions over the query feature using the processor circuitry and the different kernels to propagate contextual information from at least one support feature to at least one query feature to produce one or more updated query features; and
using the one or more updated query features and the processor circuitry, segmenting the at least one query image to produce at least one predicted query mask.

2. The method of claim 1, comprising performing support activation, using processor circuitry and a relatively higher level support feature and a relatively higher level query feature respectively associated with the at least one support image and the at least one query image, to generate an initial pseudo-mask of a target object in the query image.

3. The method of claim 2, wherein the performing the support activation comprises:
generating multiple activation maps, using the processor circuitry, by performing region-to-region matching based on the higher level support feature, a corresponding binary support mask, and the higher level query feature.

4. The method of claim 3, wherein the performing region-to-region matching includes generating support regions and query regions using the processor circuitry and a fixed window respectively sliding on a corresponding support feature and a corresponding query feature.

5. The method of claim 2, comprising generating multiple activation maps from which a mean is determined to generate the initial pseudo-mask of the target object in the query image.

6. The method of claim 2, comprising performing feature filtering, using the processor circuitry and the initial pseudo-mask and a relatively middle level support feature and a relatively middle level query feature, respectively associated with the at least one support image and the at least one query image, to generate a refined pseudo-mask to filter background information not associated with the higher level query feature.

7. The method of claim 6, wherein the performing feature filtering includes, using the processor circuitry:
applying masked average pooling on support features to obtain a support prototype vector;
expanding the support prototype vector to match one or more dimensions of a feature map of the at least one query feature, using target object information from both the at least one support feature and the at least one query feature;
refining the pseudo-mask using a 2D convolutional layer followed by a sigmoid function; and
combining the middle level query feature with the refined pseudo-mask to obtain a filtered query feature that filters background information not associated with the higher level query feature.

8. The method of claim 1, comprising:
extracting the at least one query feature from at least one query image using a first convolutional neural network (CNN) included in or coupled to processor circuitry; and
extracting the one or more support features from the at least one support image, using a computer-implemented second CNN included in or coupled to the processor circuitry.

9. The method of claim 1, wherein the segmenting the at least one query image further comprises using the processor circuitry and a pixel-wise annotated at least one support image.

10. The method of claim 1, wherein performing multiple concurrent convolutions comprises, using the processor circuitry:
inferring optimal kernel parameters for a subset of support features, using the processor circuitry, without requiring semantic information about a query feature.

11. The method of claim 10, wherein the inferring optimal kernel parameters comprises using at least one square kernel and at least two asymmetric kernels.

12. The method of claim 1, further comprising using the processor circuitry for performing K-shot segmentation using K support images and corresponding K masks, extracting foreground vectors together using K image-mask pairs.

13. The method of claim 1, comprising training a convolutional neural network using binary cross-entropy loss (BCE) between a predicted mask and a ground truth mask.

14. A device-readable medium, including stored encoded instructions for configuring a processor for performing the method of claim 1.

15. A computer-implemented method of semantic image segmentation of at least one query image associated with at least one query feature based on at least one support image associated with at least one support feature, the method comprising:
using at least one first support feature extracted from the at least one support image and at least one first query feature extracted from the at least one query image, generating an initial pseudo-mask of a target object in the query image;
using the initial pseudo-mask and at least one second support feature from the at least one support image and at least one second query feature from the at least one query image and processor circuitry, generating a refined pseudo-mask to filter background information not associated with the first query feature;
performing multiple concurrent convolutions over the query feature using different kernels to propagate contextual information from at least one support feature to at least one query feature to produce one or more updated query features, wherein the different kernels are generated from the at least one first support feature and respectively have a different symmetry characteristic; and
using the one or more updated query features and the processor circuitry, segmenting the at least one query image to produce at least one predicted query mask.

16. The method of claim 15, comprising performing support activation, using processor circuitry and a relatively higher level support feature and a relatively higher level query feature respectively associated with the at least one support image and the at least one query image, to generate an initial pseudo-mask of a target object in the query image.

17. The method of claim 16, wherein the performing the support activation comprises:
generating multiple activation maps, using processor circuitry, by performing region-to-region matching based on the higher level support feature, a corresponding binary support mask, and the higher level query feature.

18. The method of claim 17, wherein the performing region-to-region matching includes generating support regions and query regions using the processor circuitry and a fixed window respectively sliding on a corresponding support feature and a corresponding query feature.

19. The method of claim 15, comprising performing feature filtering, using the processor circuitry and the initial pseudo-mask and a relatively middle level support feature and a relatively middle level query feature, respectively associated with the at least one support image and the at least one query image, to generate a refined pseudo-mask to filter background information not associated with a higher level query feature.

20. The method of claim 19, wherein the performing feature filtering includes, using the processor circuitry:
applying masked average pooling on support features to obtain a support prototype vector;
expanding the support prototype vector to match one or more dimensions of a feature map of the at least one query feature, using target object information from both the at least one support feature and the at least one query feature;
refining the pseudo-mask using a 2D convolutional layer followed by a sigmoid function; and
combining the middle level query feature with the refined pseudo-mask to obtain a filtered query feature that filters background information not associated with the higher level query feature.

21. A computer-implemented method of semantic image segmentation of at least one query image associated with at least one query feature based on at least one support image associated with at least one support feature, the method comprising:
performing support activation, using processor circuitry and a relatively higher level support feature and a relatively higher level query feature respectively associated with the at least one support image and the at least one query image, to generate multiple activation maps from which a mean is determined to generate an initial pseudo-mask of a target object in the query image;
performing feature filtering, using the processor circuitry and the initial pseudo-mask and a relatively middle level support feature and a relatively middle level query feature, respectively associated with the at least one support image and the at least one query image, to generate a refined pseudo-mask to filter background information not associated with the higher level query feature;
performing multiple concurrent dynamic convolutions over the higher level query feature using the processor circuitry and different corresponding prototype kernels, respectively having a different symmetry characteristic, the kernels dynamically generated from the higher level support feature to propagate contextual information from at least one support feature to at least one query feature to produce updated query features; and
providing the updated query features to a decoder, included in or coupled to the processor circuitry, for segmenting the at least one query image to produce at least one predicted query mask.

22. The method of claim 21, wherein the performing the support activation comprises:
generating the multiple activation maps, using the processor circuitry, by performing region-to-region matching based on the higher level support feature, a corresponding binary support mask, and the higher level query feature.

23. The method of claim 22, wherein the performing region-to-region matching includes generating support regions and query regions using the processor circuitry and a fixed window respectively sliding on a corresponding support feature and a corresponding query feature.

24. The method of claim 21, wherein the performing feature filtering includes, using the processor circuitry:
applying masked average pooling on support features to obtain a support prototype vector;
expanding the support prototype vector to match one or more dimensions of a feature map of the at least one query feature, using target object information from both the at least one support feature and the at least one query feature;
refining the pseudo-mask using a 2D convolutional layer followed by a sigmoid function; and
combining the middle level query feature with the refined pseudo-mask to obtain a filtered query feature that filters background information not associated with the higher level query feature.
